(19) United States
(12) Patent Application Publication
(10) Pub. No.: US 2003/0224105 A1
(43) Pub. Date: Dec. 4, 2003

(54) Apparatus and methods for forming films on substrates

(75) Inventors: Konstantinos Chondroudis, Sunnyvale, CA (US); C. Eric Ramberg, San Jose, CA (US); Martin Devenney, Mountain View, CA (US); Keith Cendak, Millbrae, CA (US); Sum Nguyen, Fremont, CA (US); Qun Fan, Fremont, CA (US); Xuejun Wang, Fremont, CA (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Symyx Technologies, Inc.

(21) Appl. No.: 10/158,375

(22) Filed: May 30, 2002

(51) Int. Cl. B05D 3/12

(52) U.S. Cl. 427/240; 427/346; 427/348; 118/52; 118/320; 118/321; 118/323

(57) ABSTRACT

In a method and apparatus for forming a plurality of films on the surface of a substrate, at least two liquid samples are deposited by a deposition device onto the substrate surface. The substrate is moved so that the liquid samples on the substrate are subjected to a non-contact spreading force sufficient to cause the samples to spread over the surface to form a respective film thereon. At least a portion of each film is discrete from one or more other films formed on each substrate surface. In another embodiment, liquid samples of different compositions are deposited on an array of substrates. The liquid samples on at least two of the substrates are subjected to non-contact spreading forces during overlapping durations of time whereby the spreading forces are sufficient to cause the samples to spread over respective surfaces of the substrates to form films thereon.

### BACKGROUND OF THE INVENTION

The present invention relates generally to the formation of films on one or more substrates for screening and characterization of the film properties, and more particularly to apparatus and methods for forming such films from liquid samples.

Combinatorial synthesis and evaluation of arrays of films enables the rapid discovery of new materials with novel chemical and physical properties and the rapid optimization of previously known materials. Such techniques are currently employed to evaluate materials such as superconductors, zeolites, magnetic materials, phosphors, nonlinear optical materials, thermoelectric materials, and high and low dielectric materials. For example, U.S. Pat. No. 6,030,917 (Weinberg, et al.), the entire disclosure of which is incorporated herein by reference, discloses techniques for the combinatorial synthesis of arrays of organometallic compounds and catalysts. Using the various synthesis methods disclosed therein, arrays containing thousands or millions of different elements can be formed. Such techniques have met with success in, for example, screening various ligands such as peptides and oligonucleotides to determine their relative binding affinity to a receptor such as an antibody.

In the past, it has been disclosed that arrays of materials may be prepared by a variety of techniques, including chemical vapor deposition, physical vapor deposition or liquid dispensing. U.S. Pat. No. 6,004,617 (Schultz et al. and U.S. Pat. No. 6,333,196 (Willson et al.) disclose a variety of methods for synthesizing and screening arrays of materials for useful properties. However, when applying combinatorial techniques to a particular problem, the optimal techniques to apply to array or library design, synthesis, screening and/or informatics may not be straightforward. For example, Schultz et al. disclose using spin-coating to deposit components of materials onto a substrate in regions. As an additional example, U.S. Pat. Nos. 6,313,044 and 6,291,628 disclose that it is known in the semiconductor industry to coat the entire surface of a semiconductor wafer using what is commonly referred to as spin-coating technology. Conventional spin-coating techniques involve forming a liquid solution by dissolving a material in a volatile solvent and then depositing the liquid solution on the center of a wafer. The wafer is then rotated by a spin-coating device at a high speed to spread the material across the entire wafer surface and to facilitate evaporation of the solvent, thereby leaving a thin film coating on the wafer surface. The liquid solution is thus spread over the substrate surface without directly touching the solution, such as with a finger, doctor blade, brush or the like so as to minimize the risk of contaminating the solution. However, conventional spin-coating techniques are generally disadvantageous for use in synthesizing an array of films, primarily because only a relatively large (e.g., 3-6 inch diameter), single wafer is coated at a time or additional steps, such as masking schemes, must be used.

### SUMMARY OF THE INVENTION

In general, a method of the present invention for forming a plurality of films on a surface of a substrate comprises depositing at least two liquid samples on the substrate surface in generally spaced relationship with each other. The substrate is moved so that the liquid samples on the substrate are subjected to a spreading force sufficient to cause each sample to spread over the substrate surface to form a respective film thereon. At least a portion of each film is discrete from one or more other films formed on the substrate surface.

In another embodiment, the method generally comprises depositing at least two liquid samples on the substrate surface in generally spaced relationship with each other. The liquid samples on the substrate surface are subjected to a non-contact spreading force sufficient to cause each sample to spread over the substrate surface to form a respective film thereon. At least a portion of each film is discrete from one or more other films formed on the substrate surface. At least one characteristic of at least one of the films formed on the substrate surface is then characterized.

A method of forming a film on a surface of a substrate generally comprises depositing a liquid sample on the substrate surface at a location generally offset from a center of the substrate surface whereby the liquid sample covers substantially less than the entire surface of the substrate. The substrate is moved so that the liquid sample is subjected to a spreading force sufficient to cause the liquid sample to spread over the substrate surface to form a film thereon whereby the film covers less than the entire surface of the substrate.

In another embodiment, the method generally comprises depositing a liquid sample on the substrate surface and oscillating the substrate to subject the liquid sample to a spreading force sufficient to cause the liquid sample to spread over the substrate surface to form a respective film thereon.

In yet another embodiment, the method generally comprises depositing a liquid sample on the substrate surface whereby the liquid sample covers substantially less than the entire surface of the substrate. A pressurized gas is directed to impact the liquid sample to apply a spreading force thereto sufficient to cause the liquid sample to spread over the substrate surface to form a film thereon.

In general, a method of forming an array of films for use in screening at least one characteristic of each of the films comprises depositing at least two liquid samples onto at least one substrate such that the at least two liquid samples are at least partially discrete from each other. The at least one substrate is moved so that the liquid samples are subjected to a spreading force during overlapping durations of time. The spreading force is sufficient to cause each liquid sample to spread over the at least one substrate to form a respective film thereon. At least a portion of each film is discrete from one or more other films formed on the at least one substrate.

In another embodiment, the method comprises depositing at least two liquid samples onto at least one substrate such that the at least two liquid samples are at least partially discrete from each other. The liquid samples are subjected to a non-contact spreading force during overlapping durations of time whereby the spreading force is sufficient to cause each liquid sample to spread over the at least one substrate to form a respective film thereon. At least a portion of each film is discrete from one or more other films formed on the at least one substrate.

In general, a method of effecting the parallel formation of films comprises depositing liquid samples of different compositions on an array of substrates wherein each substrate has a surface for receiving a respective sample. The liquid samples on at least two of the substrates are subjected to non-contact spreading forces during overlapping durations of time whereby the spreading forces are sufficient to cause the samples to spread over respective surfaces of the substrates to form films on the surfaces.

In another embodiment, the method comprises depositing liquid samples of different compositions on an array of substrates wherein each substrate has a surface for receiving a respective sample. At least two of the substrates of the array are moved during overlapping durations of time to subject the samples on the at least two substrates to spreading forces sufficient to cause the samples to spread over respective surfaces of the substrates to form films on the surfaces.

In yet another embodiment, movement of the at least two substrates is controlled by using a single controller programmed to vary the movement of the substrates according to a predetermined program.

In still another embodiment, the method generally comprises operating a robot system to deposit liquid samples on an array of substrates wherein each substrate has a surface for receiving a respective sample. At least two of the substrates of the array are moved during overlapping durations of time to subject the samples on the at least two substrates to spreading forces sufficient to cause the samples to spread over respective surfaces of the substrates to form films on the surfaces.

In another embodiment, the method comprises depositing liquid samples on an array of substrates occupying an area having a maximum dimension of no greater than about five feet, wherein each substrate has a surface for receiving a respective sample. At least two of the substrates of the array are moved during overlapping durations of time to subject the samples on the at least two substrates to spreading forces sufficient to cause the samples to spread over respective surfaces of the substrates to form films on the surfaces.

In another embodiment, the method generally comprises depositing liquid samples on an array of substrates wherein each substrate has a surface for receiving a respective sample. At least two of the substrates of the array are moved in different ways during overlapping durations of time to subject the samples on the at least two substrates to spreading forces sufficient to cause the samples to spread over respective surfaces of the substrates to form films on the surfaces.

Apparatus of the present invention for forming a plurality of films on a surface of a single substrate generally comprises a deposition device adapted for depositing a plurality of liquid samples on the surface of the substrate in generally spaced relationship with each other. A movement device is capable of supporting the substrate with the liquid samples deposited thereon and is operable to move the substrate to thereby subject the liquid samples to a spreading force sufficient to cause the samples to spread over the substrate surface to form respective films thereon.

In another embodiment, apparatus for forming a film on a surface of a substrate generally comprises a deposition device for depositing a liquid sample on the surface of the substrate. A movement device is capable of supporting the substrate with the liquid sample deposited thereon and is operable to subject the substrate to non-rotational movement whereby the non-rotational movement subjects the liquid sample to a spreading force sufficient to cause the liquid sample to spread over the substrate surface to form a film thereon.

In yet another embodiment the apparatus generally comprises a deposition device adapted for depositing a liquid sample on the surface of the substrate. A support supports the substrate with the liquid sample deposited thereon. A gas delivery device is operable to direct a pressurized gas to impact the liquid sample to thereby cause the liquid sample to spread over the substrate surface to form a film thereon.

In general, apparatus of the present invention for effecting the parallel formation of films comprises an array of holders for holding a plurality of substrates wherein each substrate has a surface for receiving a liquid sample thereon. A robot system deposits liquid samples on the surfaces of the substrates in the holders. A drive system is operable to move at least two of the holders of the array during overlapping durations of time to subject the samples on the at least two substrates to spreading forces to cause the samples to spread over respective surfaces of the substrates to form films on the surfaces.

In another embodiment, the apparatus generally comprises an array of holders occupying an area having a maximum dimension of no greater than about five feet wherein each holder is adapted for holding a substrate having a surface for receiving a liquid sample thereon. A drive system is operable to move at least two of the holders of the array during overlapping durations of time to subject the samples to spreading forces sufficient to cause the samples to spread over respective surfaces of the substrates to form films on the surfaces.

In yet another embodiment, the apparatus generally comprises an array of substrates wherein each substrate has a surface for receiving a liquid sample thereon. A drive system operates to move at least two of the substrates of the array during overlapping durations of time to subject the samples on the at least two substrates to spreading forces sufficient to cause the samples to spread over respective surfaces of the substrates to form films on the surfaces. A programmable control system controls the drive system to move the substrates according to a predetermined program.

### BRIEF DESCRIPTION OF THE DRAWINGS

FIG. 1 is a schematic perspective of a first embodiment of apparatus of the present invention for forming films on substrates;

FIG. 2 is a photograph of films formed on a substrate using the apparatus of FIG. 1;

FIG. 3 is side elevation of a movement device of a second embodiment of apparatus of the present invention shown supporting a substrate;

FIG. 4 is a top plan view of the movement device of FIG. 3 with the substrate omitted;

FIG. 5 is a photograph of films formed on a substrate using the movement device of FIG. 3;

FIG. 6 is a perspective of a movement device of a third embodiment of apparatus of the present invention shown supporting a substrate;

FIG. 7 is a side elevation thereof with portions omitted to reveal internal construction and with other portions shown in cross-section;

FIG. 8 is a photograph of films formed on a substrate using the movement device of FIG. 6;

FIG. 9 is a schematic side view of a substrate holder and an air knife of a fourth embodiment of apparatus of the present invention, with the air knife shown in cross-section;

FIG. 10 is a top view of the substrate holder and air knife of FIG. 9;

FIG. 11 is a side elevation of apparatus of a fifth embodiment of the present invention;

FIG. 12 is a top plan view thereof of the apparatus of FIG. 11;

FIG. 13 is a perspective of a portion of the apparatus of FIG. 11 showing a drive system and an array of substrate holders of the apparatus;

FIG. 14 is a top plan view of the drive system and substrate holders of FIG. 13;

FIG. 15 is a side elevation of the drive system and substrate holders of FIG. 13;

FIG. 16 is a cross-section taken in the plane of line 16-16 of FIG. 14 with a control system for the drive system shown schematically;

FIG. 17 is a fragmented cross-section of one substrate holder of the apparatus of FIG. 11;

FIG. 18 is a perspective of one substrate holder driven by a corresponding motor;

FIG. 19 is an exploded perspective of the substrate holder and motor of FIG. 18;

FIG. 20 is a cross-section of an array of substrate holders and a second embodiment of a drive system for the substrate holders; and

FIG. 21 is a schematic side view of apparatus of a sixth embodiment of the present invention showing a heater for heating substrates on which films are formed.

Corresponding reference characters indicate corresponding parts throughout the drawings.

### DETAILED DESCRIPTION OF THE INVENTION

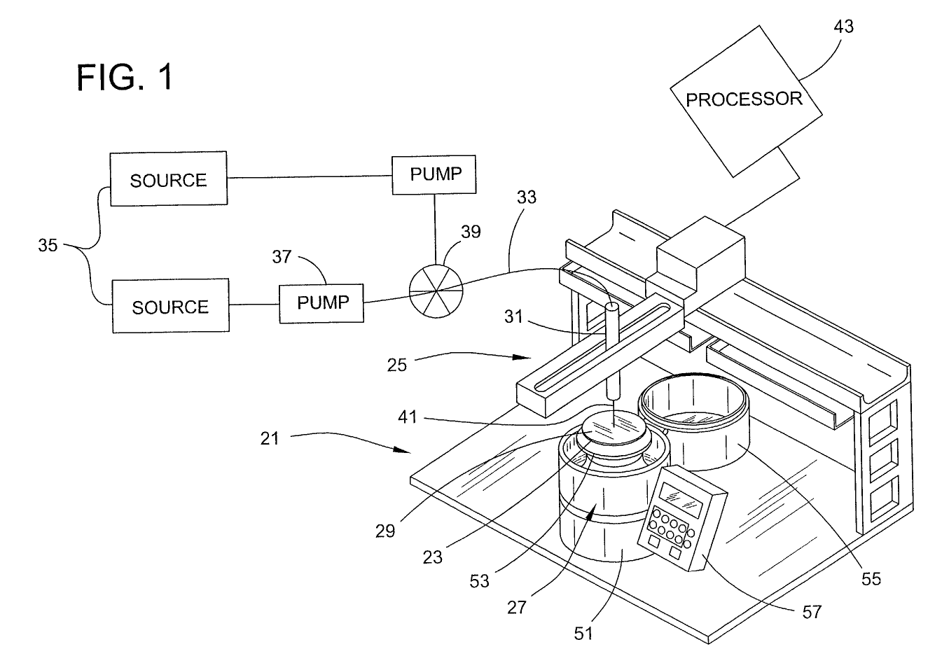

With reference now to the drawings, and in particular to FIG. 1, apparatus of a first embodiment of the present invention for forming films on substrates is indicated it its entirety by the reference numeral 21. The apparatus 21 is more particularly for forming an array of such films on the surface of a single substrate 23, and even more particularly for the parallel formation of an array of such films on the substrate. The apparatus 21 comprises a deposition device, generally indicated at 25, for depositing one or more liquid samples on the surface of the substrate 23. A movement device, generally indicated at 27, supports the substrate 23 and is capable of moving the substrate to subject the liquid samples to a spreading force, and more particularly to a non-contact spreading force, so as to spread the liquid samples on the substrate and thereby form relatively thin films on the substrate. As used herein, a non-contact spreading force is defined as a force acting on the liquid samples on the substrate 23 by means other than directly contacting the liquid samples with an implement (e.g., other than the substrate itself), such as a doctor blade or other spreading implement, or with a jetted media.

The substrate 23 may be constructed of substantially any material which allows for the formation of films thereon and the subsequent screening of various properties and characteristics of such films. For example, the substrate 23 may be organic, inorganic, biological, nonbiological, or a combination of any of these, and may have any convenient shape, such as a disc, square, sphere, circle, etc. The substrate 23 may be constructed of polymers, plastics, pyrex, quartz, resins, silicon, silica or silica-based materials, carbon, metals, inorganic glasses, inorganic crystals, membranes or other suitable materials which will be readily apparent to those of skill in the art. The substrate 23 has a surface 29 on which the films are to be formed and which may be composed of the same materials as the substrate or, alternatively, the substrate may be coated with a different material to define the exposed substrate surface. Moreover, the substrate surface 29 may be modified without departing from the scope of the invention. For example, for film formation on a hydrophilic silicon substrate using a hydrophobic liquid, the surface can be rendered hydrophobic, if desired, by treating it with Hexamethyldisilazane (HMDS). For other applications, the ambient atmosphere could be modified to further affect the liquid solution/substrate interface (e.g., wetting angle).

The substrate 23 of the illustrated embodiment is a conventional semiconductor wafer having a surface 29 processed to a mirror-like finish to facilitate uniformity of thickness of the films formed thereon. However, it is understood that the substrate surface 29 may have a variety of alternative surface characteristics, depending on the film properties and characteristics to be measured, without departing from the scope of this invention. For example, the substrate surface 29 may have raised or depressed regions on which the synthesis of diverse materials takes place. The wafer shown in FIG. 1 has a diameter of approximately five inches. However, the size of the substrate 23 may be substantially larger or smaller, such as down to about 0.5 inches, depending on the size and number of films to be formed on the substrate.

Still referring to FIG. 1, the deposition device 25 is a robotic device in which a pipette, or probe 31 of the device is manipulated over the substrate surface 29 using a 3-axis translation system. The probe 31 is connected by flexible tubing 33 to one or more sources of liquid from which the films are to be formed. One or more pumps 37 are located along the flexible tubing 33 to draw liquid from the liquid sources and to deliver the liquid to the probe 31. Suitable pumps 37 include peristaltic pumps and syringe pumps. A multi-port valve 39 is disposed in the flexible tubing 33 downstream of the pump(s) 37 to control which liquid is drawn from the liquid sources and delivered to the probe 31 for dispensing onto the substrate 23. The probe 31 includes a tip 41 which broadly defines an outlet of the probe through which small, metered samples of liquid are dispensed onto the substrate surface 29. The tip 41 is preferably spaced above the substrate surface 29 about 0.1 cm to about 6 cm during deposition of liquid onto the substrate 23. While the deposition device 25 of FIG. 1 is illustrated as having a single probe 31 and tip 41, it is understood that the device may have multiple probes 31 and/or multiple tips 41 for delivering multiple liquid samples onto the substrate surface 29 without departing from the scope of this invention. For example, multiple probes 31 each having a corresponding tip 41 may be arranged in a single row or in an array, and may deliver liquid samples onto the substrate surface 29 either serially or concurrently.

The robotic deposition device 25 of the illustrated embodiment is controlled by a processor 43 in which the operator inputs various operating parameters to the device using a software interface. Typical operating parameters include the substrate surface 29 coordinates at which each liquid sample is to be deposited thereon and the liquid sources from which liquid is delivered to the probe for deposition onto the substrate surface. General construction and operation of robotic deposition devices similar to the deposition device 25 of the illustrated embodiment is known in the art and will not be further described herein except to the extent necessary to describe the present invention.

It is also understood that other suitable deposition devices may be used to deposit small, metered liquid samples onto the substrate surface 29 without departing from the scope of the present invention. For example, the deposition device 25 may include a plurality of probes for delivering multiple liquid samples to multiple locations on the substrate surface 29 either sequentially or concurrently. Also, the substrate surface 29 may be moved relative to the probe 31 instead of, or in addition to, the probe being moved relative to the substrate 23. Moreover, the deposition device 25 may be operated manually, instead of robotically, without departing from the scope of the present invention.

The probe tip 41 dispenses liquid therefrom generally in the form of droplets, or samples of liquid. The volume of each liquid sample deposited onto the substrate surface 29 generally depends on the amount of liquid needed to obtain a desired film size. For example, based on limitations inherent in existing film screening techniques and devices, each film is desirably sized to have a surface area of at least about 0.1 mm², preferably in the range of about 0.1 mm² to about 700 mm², and more preferably in the range of about 1 mm² to about 50 mm². The volume of each liquid sample deposited on the substrate surface 29 is preferably in the range of about 0.1 microliters to 10 milliliters, more preferably in the range of about 0.5 microliters to about 500 microliters, still more preferably in the range of about 0.5 microliters to about 100 microliters, even more preferably in the range of about 0.5 microliters to about 50 microliters and most preferably in the range of about 1 microliter to about 10 microliters.

The liquid from which each film is formed may be substantially any liquid solution or dispersion from which a film remains upon evaporation of the liquid. For example, the liquid may be a material for which its evaporation, decomposition or otherwise reaction creates films formed of polyimide, silicon dioxide, organic polymers, ceramic materials, composite materials (inorganic composites, organic composites and combinations), photoresists, sol-gel solutions including polymeric metal (organic) oxoalkoxides, other metallo-organic compounds, polymer based light-emitting materials including plastic, solutions and suspensions of ferroelectric materials, and optical coatings. The liquid may also comprise biological materials including antibodies, antigens, DNA, RNA, proteins, enzymes, oligopeptides, polypeptides, oligosaccharides, mono and polysaccharides, and lipids.

The thickness of the films formed on the substrate surface 29 is generally a function of various properties of the liquid from which the film is formed, such as the viscosity, the wettability (e.g., how well the liquid coats the substrate surface) and the volatility (e.g., the vapor pressure) of the solution or dispersing medium, and the amount of spreading force applied to the liquid samples by the movement device 27 as will be described. Generally, the more viscous the liquid sample, the thicker the resulting film will be for a given spreading force. Alternatively, for a more viscous liquid sample, the spreading forces acting on the sample can be varied to obtain a desired film thickness. As an example, the viscosity of the liquid sample is preferably in the range of about 1E⁻⁴ to about 1E⁴ Pa-sec, more preferably in the range of about 5E⁻⁴ to about 1E³ Pa-sec, still more preferably in the range of about 1E⁻³ to about 1E² Pa-sec, and most preferably in the range of about 1E⁻² to 1E¹ Pa-sec.

For some materials it may be desirable or even necessary to lower the viscosity of the material by dissolving or dispersing the material in a solvent to facilitate the formation of a thinner film. Such a solvent preferably has a boiling point in the range of about −100° C. to about 1,000° C., more preferably in the range of about −50° C. to about 500° C., and most preferably in the range of about 25° C. to about 200° C. However, the more volatile the solvent, the faster it will evaporate after the liquid is deposited onto the substrate surface 29. Consequently, as the volatility of the solvent increases, the spreading force required to form the desired film size before the liquid stops spreading over the substrate surface 29 also increases.

The thickness of each film formed on the substrate surface 29 is preferably in the range of about 50 Å to about 1000 micrometers, and more preferably in the range of about 1,000 Å to about 10 micrometers, and even more preferably in the range of about 1,000 Å to about 10,000 Å. In one preferred embodiment, a portion of the surface area of each film formed on the substrate 23 has a substantially uniform thickness to facilitate more accurate screening of the film. For example, a portion of each film preferably has a thickness which is uniform to within a variation of about 0% to about 20%, more preferably to within a variation of about 0% to about 10%, still more preferably to within a variation of about 0% to about 5% and most preferably to within a variation of about 0% to about 3%. The size (e.g., surface area) of a region within each film formed on the substrate surface 29 is preferably at least about equal to the minimum size required by the measurement method used to characterize the film, and is more preferably up to about three times larger than the minimum size required by the measurement method.

With further reference to FIG. 1, the movement device 27 of the illustrated embodiment is a non-oscillatory, or non-reciprocating device, and is more particularly a spin-coating device capable of uni-directional rotation on a rotation axis thereof to subject the liquid sample to subject the liquid samples on the substrate surface 29 to a generally monotonic non-contact spreading force. The spin-coating device 27 comprises a cylindrical housing 51, a motor (not shown) enclosed within a lower portion of the housing, a drive shaft (not shown) rotatably driven by the motor and defining the rotation axis of the device, and a chuck 53 mounted coaxially on the drive shaft for conjoint rotation therewith on the rotation axis of the device. General construction and operation of spin-coating devices similar to that of the illustrated embodiment is known in the art and will not be further described herein except to the extent necessary to describe the present invention.

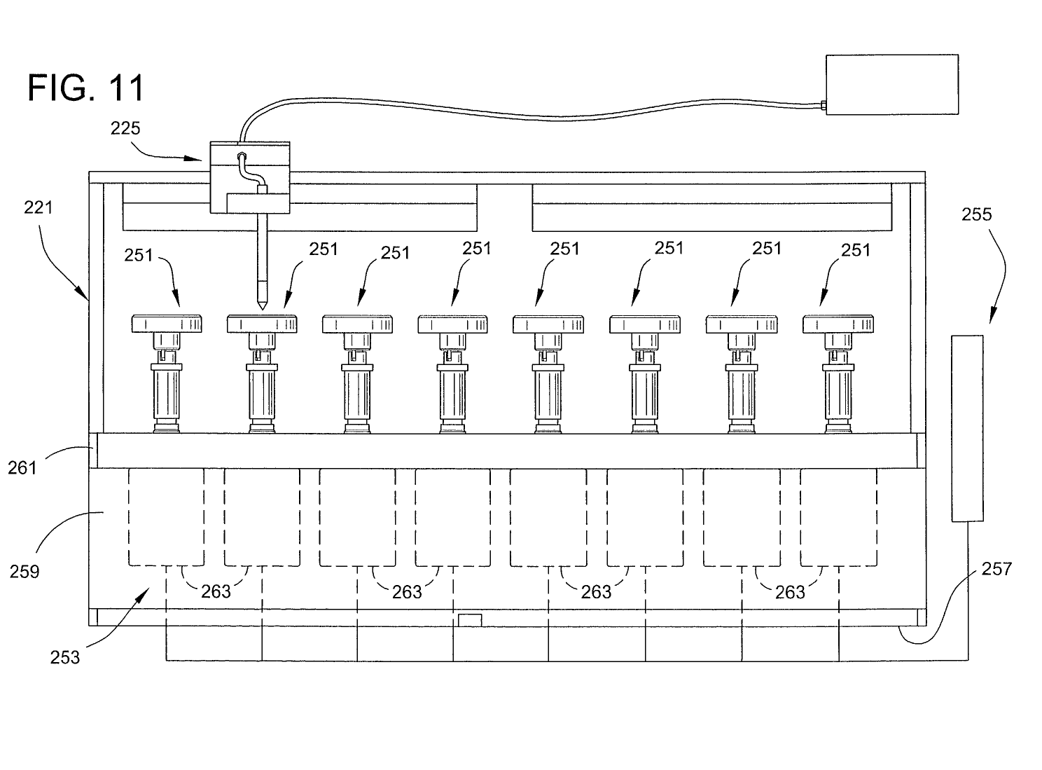

For example, one preferred spin-coating device 27 is available from Laurell Technologies Corporation of Pennsylvania under the model designation WS-400A-6NPP. The cylindrical housing 51 has an internal diameter of about 8.5 inches and a height of about 12 inches. A closure 55 is hinged to the housing 51 to permit closing of the housing during operation of the device 27. The chuck 53 of the illustrated embodiment is a vacuum chuck in fluid communication with a vacuum source (not shown) for suctioning the substrate 23 down against the chuck during operation of the spin-coating device 27. However, it is understood that the substrate 23 may be supported on the drive shaft by means other than a vacuum chuck, such as by mechanical retainers (not shown) or other suitable means without departing from the scope of this invention. The spin-coating device 27 shown in FIG. 1 can support a substrate 23 having a diameter of about three to about six inches and is capable of uni-directional rotation at speeds of up to at least about 6000 rpm. It is contemplated that where a smaller substrate is used, the spin-coating device 27 may be substantially smaller than that shown in FIG. 1. For example, one of the spin-coating devices shown in FIG. 11 and described later herein may be used to rotate a smaller substrate, such as a substrate having a diameter (or width) of about 0.5 inches.

Still referring to FIG. 1, a control system 57 is in electrical communication with the spin-coating device 27 for controlling operation thereof. The control system 57 is preferably a computer based system capable of sending data to and receiving data from the spin-coating device 27 to monitor and control operation of the device. Such data preferably include a motor start time, rotational acceleration and speed, duration of motor operation and other relevant parameters. The control system 57 is also desirably programmable to permit a pre-determined parameter profile, such as a rate of acceleration, duration of operation, rotational speed and stop time to be pre-programmed. For example, the control system 57 may be programmed such that following deposition of one or more liquid samples on the substrate 23, the substrate is subjected to rotation for an initial time period, such as about 5-10 seconds, at a relatively low rotational speed, such as about 500 rpm, to promote spreading of the liquid samples on the substrate surface 29. The substrate 23 may then be accelerated to a higher rotational speed, such as about 2000 rpm for a longer duration, such as about 40 seconds, to promote further evaporation of the liquid. It is believed that the hardware and software components of the control system 57 will be readily apparent to those of ordinary skill in this field and therefore will not be described in more detail.

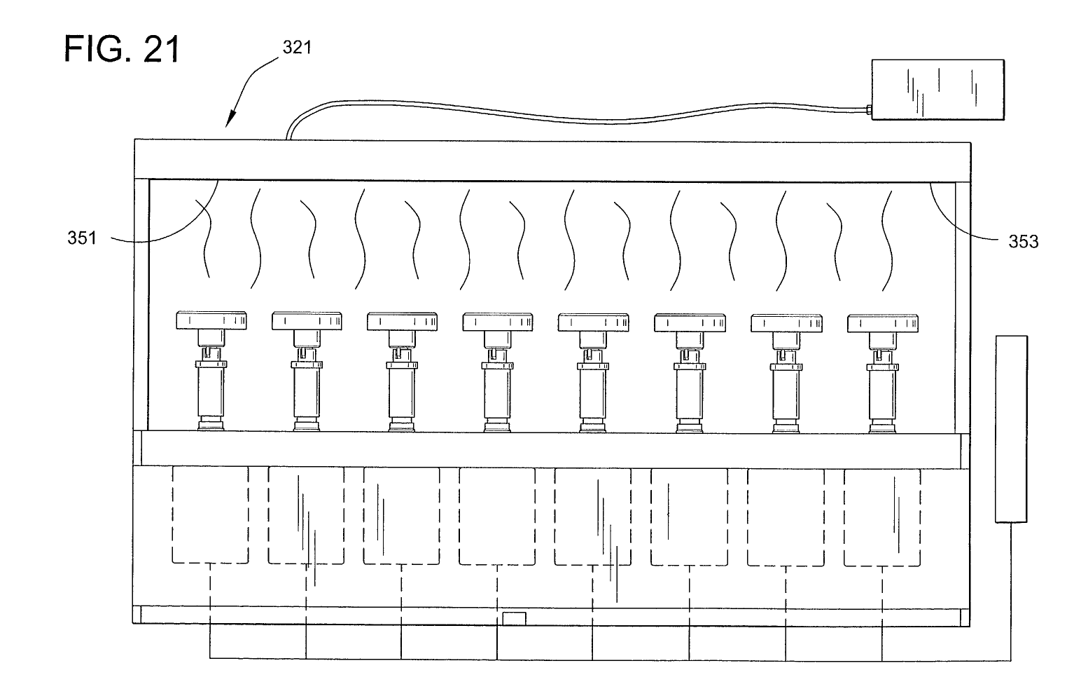

A heater (not shown in FIG. 1 but similar to a heater 353 shown in FIG. 21 and described later herein), may be positioned above the substrate 23 in opposed relationship with the substrate surface 29, such as at a distance of about 1 mm up to about 100 mm, to heat the substrate, ambient environment and/or liquid samples deposited on the substrate 23 during operation of the spin-coating device 27. The heater is preferably capable of generating heat at a temperature in the range of about 25° C. to about 500° C., more preferably in the range of about 50° C. to about 450° C., and most preferably in the range of about 100° C. to about 400° C. As an example, one preferred such heater is a flat panel infrared heater available from Ogden of Arlington Heights, Ill. under the model designation FP2017 and is operable to generate heat at a temperature of up to about 200° C. Alternatively, it is understood that a cooling device (not shown) may be used to cool the substrate, ambient environment and/or liquid samples without departing from the scope of this invention.

In operation according to a method of the present invention for forming films on a substrate surface 29, and more particularly for forming thin films from liquid samples on the surface of a single substrate, a substrate 23 is secured to the chuck 53 of the spin-coating device 27 generally coaxially with the rotation axis of the device and with the mirror-finish surface of the substrate exposed (e.g., facing up as shown in FIG. 1). The deposition device 25 is then operated to deposit one or more liquid samples on the exposed substrate surface 29. The samples may be deposited serially, such as by the device 25 shown in FIG. 1, or simultaneously, such as by a deposition device (not shown) having multiple probes. It is contemplated that if only one liquid sample is deposited on the substrate surface 29, it may be located offset from the center of the substrate 23 (e.g., relative to the rotation axis of the spin-coating device). In the event more than one liquid sample is deposited on the substrate 23, the liquid samples are preferably deposited thereon in spaced relationship with each other, with the samples all being generally offset from the center of the substrate or with one of the samples being deposited at the center of the substrate.

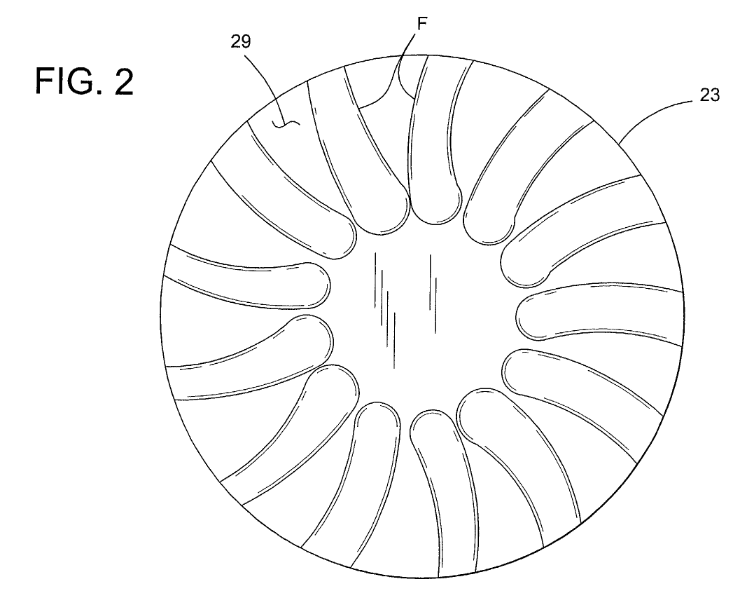

The spin-coating device 27 is then operated to rotate the substrate 23 on the rotation axis of the device. The rotation of the substrate 23 subjects the liquid samples on the substrate surface 29 to a non-contact spreading force, resulting in a shear stress at the liquid sample/substrate surface interface. When sufficiently large, this shear stress causes the liquid to spread or flatten on the substrate surface 29 to facilitate thinning of the liquid and evaporation thereof to thereby form corresponding thin films on the substrate surface. For example, uni-directional rotation of the substrate 23 by the spin-coating device 27 of FIG. 1 subjects the liquid samples to a generally monotonic spreading force sufficient to spread or flatten the samples generally tangentially and/or radially outward on the substrate surface 29 as illustrated by the films formed on the substrate shown in FIG. 2.

The liquid samples may be deposited on the substrate surface 29 with sufficient spacing therebetween such that the corresponding films formed on the substrate surface remain discrete from each other. However, it is understood that portions of adjacent films may overlap each other and remain within the scope of this invention, as long as a portion of each film remains sufficiently discrete from other films on the substrate surface to permit the desired screening of each different film. For example, an area of at least about 0.1 mm² of each film formed on the substrate 23 is preferably discrete from other films formed thereon. It is also understood that certain experimental designs may require overlap between films, e.g., to investigate multilayer phenomena. It is also contemplated that the liquid samples may alternatively be deposited onto the substrate surface 29 during operation of the spin-coating device 27 so that the substrate surface is already rotating as liquid samples are deposited thereon.

### EXAMPLE 1

The above method was used to form a plurality of silica-based films for the evaluation of their dielectric, optical, mechanical and chemical properties. A liquid solution comprising a silica source, a catalyst, a surfactant and a solvent was prepared and used as a liquid source for the deposition device 25 of FIG. 1. A silicon wafer having a diameter of about three inches was suctioned down against the vacuum chuck of the spin-coating device 25 of FIG. 1. The deposition device 25 was operated to serially dispense thirteen liquid samples of the solution on the exposed surface 29 of the wafer in a generally circular pattern having a diameter of about two inches, with the center-to-center spacing between adjacent samples being about 8 mm. The volume of each liquid sample was in the range of about 2-5 microliters. The control system 57 was used to operate the spin-coating device 27 according to a predetermined program pursuant to which after the deposition of each sample of liquid on the substrate 23, the substrate was rotated at an acceleration rate of about 2000 rpm/sec until the rotational speed reached about 3000 rpm (e.g., about 1.5 seconds), and rotation then continued at a speed of 3000 rpm for about 5-10 seconds.

The control system 57 then caused rotation of the substrate 27 to stop while another sample of liquid was deposited on the substrate surface 29. Rotation of the substrate 23 subjected the liquid samples to a non-contact spreading force, resulting in the liquid samples spreading radially and tangentially outward on the wafer surface to form films thereon. FIG. 2 illustrates the pattern of corresponding films F formed on the wafer surface 29.

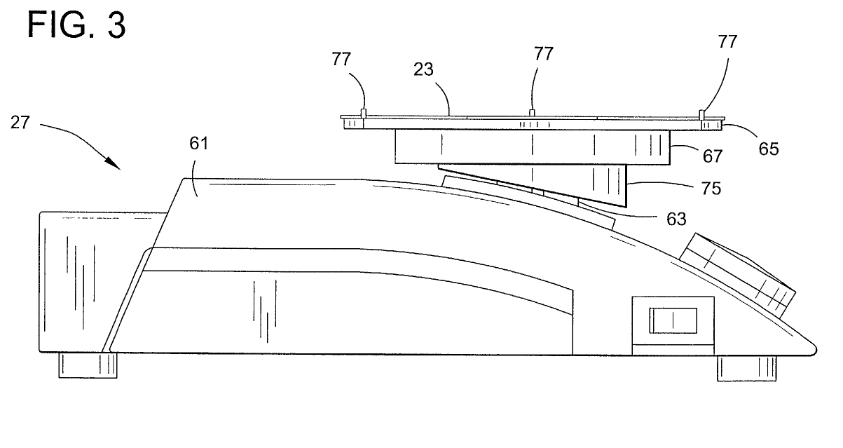

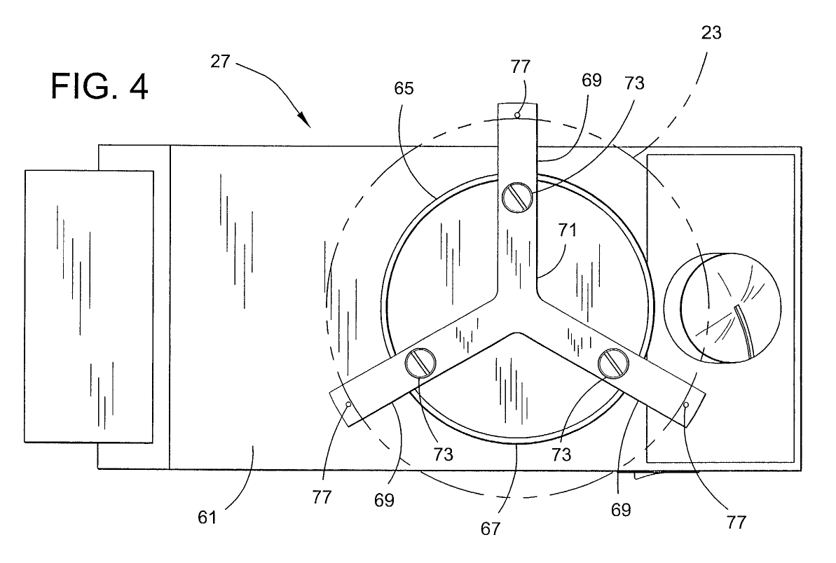

A movement device 27 of a second embodiment of apparatus 21 of the present invention is shown in FIGS. 3 and 4. In this embodiment, the movement device 27 is an oscillatory movement device, and more particularly an orbital movement device capable of oscillating the substrate 27 along an orbital path. The orbital movement device 27 comprises a housing 61 and an orbital drive system (not shown) operatively connected to an orbiting member (FIG. 3) for driving eccentric orbital movement of the orbiting member. The orbiting member 27 of the illustrated embodiment extends up out of the housing 61 and has a substrate holder 65 mounted thereon for conjoint orbital movement with the orbiting member. General construction and operation of orbital movement devices is known in the art and will not be further described herein except to the extent necessary to describe the present invention.

As an example, one preferred orbital movement device 27 is available from IKA-Works, Inc. of Wilmington, N.C., U.S.A., under the model designation MS1 MINISHAKER. The device 27 is capable of driving orbital movement of the substrate holder 65 (and hence the substrate 23 supported by the holder 65) at a speed in the range of about 200 rpm to about 2500 rpm along an eccentric path of up to about 0.177 inches on a major axis and up to about 0.089 inches on a minor axis. In the particular embodiment shown, the holder 65 comprises a base 67 adapted for connection with the orbiting member 19, and three arms 69 (FIG. 4), or spokes extending radially outward from a central hub 71 and secured to the base by suitable fasteners 73. The base 67 of the holder 67 includes a skirt 75 formed integrally therewith and depending therefrom. The skirt 75 is tapered in accordance with the contour of the housing 61 to generally surround and shield the portion of the orbiting member 63 which extends outward of the housing. As seen best in FIG. 4, the arms 69 of the holder 67 are preferably in equiangular relationship with respect to one another (e.g., at angles of about 120° relative to each other). A retainer in the form of a pin 73, for example, extends up from the upper surface of each arm 69 generally adjacent its outer end. The substrate 23 thus seats on the upper surfaces of the arms 69 with the peripheral edge of the substrate 23 generally centered within the pins 73 such that the pins inhibit lateral (e.g., sliding) movement of the substrate on the holder during operation of the orbital movement device 23.

It is contemplated that the apparatus 21 of this second embodiment may also have a control system (not shown but similar to the control system 57 shown in FIG. 1) for controlling the drive system of the orbital movement device 27. For example, the control system 57 may be used to monitor and control the drive system start time, the orbital path and speed of the device, the duration of operation of the drive system and other relevant parameters. It also contemplated that a heater (not shown but similar to the heater 353 shown in FIG. 21 and described later herein) or a cooling device (not shown) may be used to heat or cool the substrate 23 and/or liquid samples during operation of the orbital movement device 27.

In operation, the substrate 23 is placed in the holder 65 of the orbital movement device 27 as described above, with the mirror-finish surface 29 exposed (e.g., facing up in the device of FIG. 3). The deposition device 25 is then operated to deposit one or more liquid samples on the exposed substrate surface 29. The liquid samples may be deposited onto the substrate surface 29 serially, such as by the device shown in FIG. 1, or simultaneously, such as by a deposition device (not shown) having multiple probes. It is contemplated that if only one liquid sample is deposited on the substrate surface 29, it may be located offset from the center of the substrate 23. In the event more than one liquid sample is deposited on the substrate 23, the liquid samples are preferably deposited thereon in spaced relationship with each other, with the samples all being generally offset from the center of the substrate or with one of the samples being deposited at the center of the substrate.

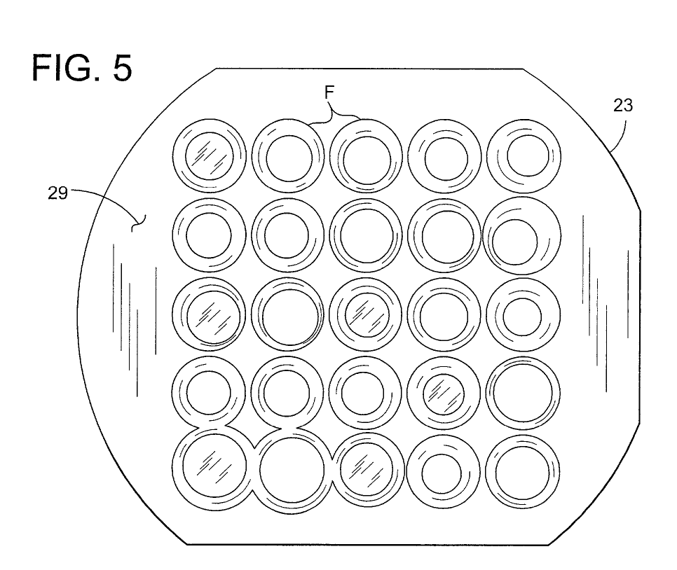

The orbital movement device 27 is then operated to drive movement of the substrate 23 along an orbital path. Orbital movement of the substrate 23 subjects the liquid samples on the substrate surface 29 to a non-contact spreading force, resulting in a shear stress at the liquid sample/substrate surface interface. When sufficiently large, this shear stress causes the liquid samples to spread or flatten on the substrate surface 29 to facilitate thinning of the liquid and evaporation thereof to thereby form corresponding thin films on the substrate surface. For example, orbital movement of the substrate 23 by the orbital movement device 27 of the illustrated embodiment causes each liquid sample to spread or flatten on the substrate surface 29 in a generally circular pattern to form generally circular films F on the substrate in FIG. 5.

The liquid samples are preferably deposited on the substrate surface 29 with sufficient spacing therebetween such that the films F formed on the substrate surface remain discrete from each other. However, it is understood that portions of adjacent films may overlap each other and remain within the scope of this invention, as long as a portion of each film remains sufficiently discrete from other films on the substrate surface 29 to permit the desired screening of each different film. For example, an area of at least about 0.1 mm² of each film formed is preferably discrete from other films formed on the substrate 23. It also contemplated that the liquid samples may alternatively be deposited onto the substrate surface 29 during operation of the orbital movement device 27 so that the substrate surface is already moving as liquid samples are deposited thereon.

### EXAMPLE 2

The apparatus 21 of the second embodiment was used to form a combinatorial array of silica-based films F for the evaluation of their dielectric, optical, mechanical and chemical properties. Different compositions of a liquid solution comprising a silica source, a catalyst, a surfactant and a solvent were prepared and used as liquid sources for the deposition device 25 (FIG. 1). A silicon wafer having a diameter of about 125 mm was placed in the holder 65 of the orbital movement device 27 of FIG. 3 in the manner described previously. The orbital movement device 27 was operated to move the wafer at a speed of about 2200 rpm along an orbital path having a major axis of about 4.5 mm and a minor axis of about 2.25 mm.

While the wafer was moving along its orbital path, the deposition device 25 was operated to serially dispense twenty-five samples of liquid on the wafer in a generally square pattern (e.g., a matrix of five rows of five samples each), with the center-to-center spacing between adjacent samples being about 17.5 mm. The volume of each liquid sample was in the range of about 2-5 microliters. Dispensing of the liquid samples on the wafer occurred over a period of about 12 minutes, and the substrate 12 was moved on its orbital path for a total duration of about 15 minutes (e.g., about 3 minutes longer than the time at which the last liquid sample is deposited on the substrate), after which orbital movement of the substrate was stopped. Orbital movement of the wafer subjected the liquid samples on the wafer surface 29 to a non-contact spreading force to facilitate spreading of the liquid samples on the wafer surface to form films thereon. FIG. 5 illustrates the pattern of corresponding films F formed on the wafer surface 29. The diameter of each of the films formed on the wafer surface 29 was approximately 17 mm.

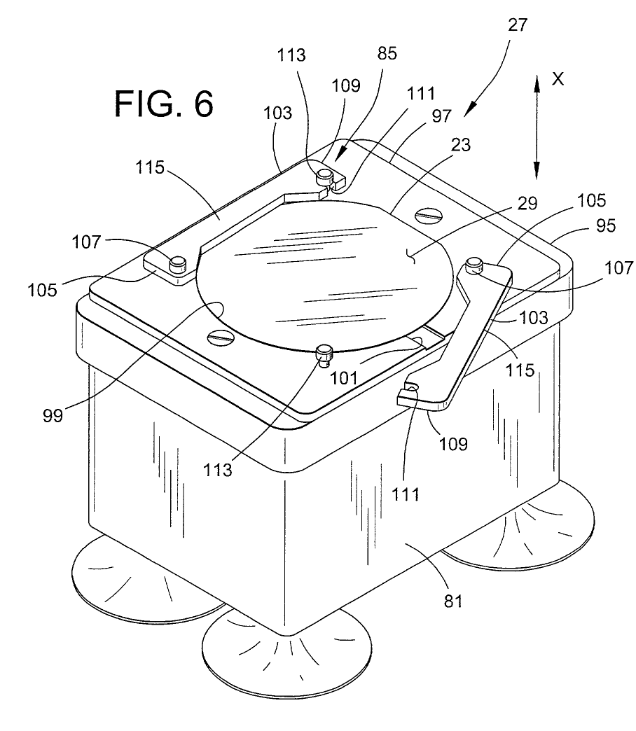

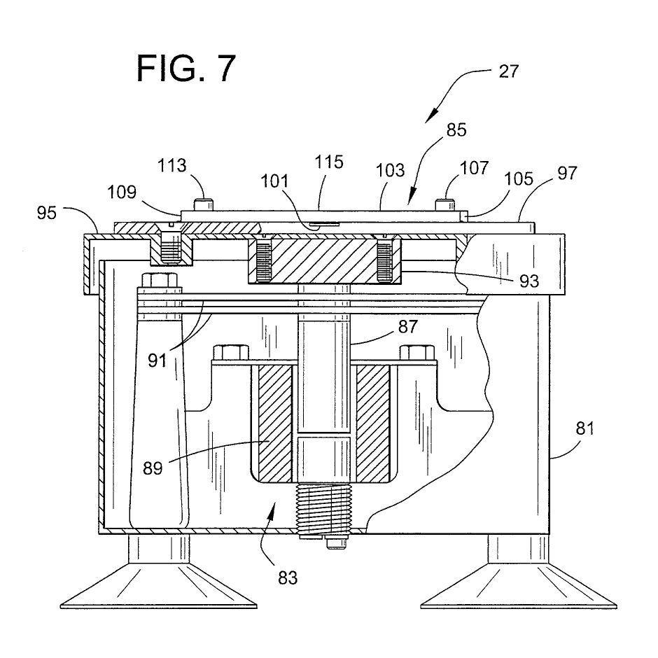

FIGS. 6 and 7 illustrate a movement device 27 of a third embodiment of apparatus 21 of the present invention in which the movement device subjects the substrate to oscillatory movement. In this embodiment, the movement device 27 is a reciprocating device and, more particularly, a linear reciprocating device capable of reciprocating the substrate 23 along a longitudinal path extending generally normal to the surface 29 of the substrate (e.g., up/down as indicated by the direction arrow in FIG. 6). The linear reciprocating device 27 generally comprises a housing 81, a drive system generally indicated at 83 in FIG. 7, and a holder, generally indicated at 85, operatively secured to the drive system for supporting the substrate 23 during operation of the device. The drive system 83 of the illustrated embodiment is an electromagnetic drive system including an armature 87 coaxially received within a central passage of an electromagnetic coil 89. The armature 87 is movable axially (e.g., vertically) relative to the coil 89 on along a longitudinal path defined by the armature. Leaf springs 91 are secured to the armature 87 toward its upper end for controlling the axial displacement of the armature. The drive system 83 also includes a generally rectangular mounting block 93 secured to the top of the armature 87 for conjoint linear reciprocation therewith. A cover plate 95 is secured to the top of the mounting block 93 for conjoint movement therewith and generally defines the top of the housing 81.

General construction and operation of linear reciprocation devices such as the device 27 described herein and illustrated in FIG. 7 as having an electromagnetic drive system 83 is known in the art and will not be further described herein except to the extent necessary to describe the present invention. For example, U.S. Pat. Nos. 3,155,853 and 4,356,911, the entire disclosures of which are incorporated herein by reference, disclose reciprocating devices having electromagnetic drive systems. One particularly preferred linear reciprocation device 27 is available from Union Scientific Corporation of Randallstown, Md., U.S.A., as a vertical electromagnetic shaker. The drive system 83 is capable of linear reciprocation at a frequency of up to about 60 Hz and an amplitude of up to about 0.15 inches.

As best seen in FIG. 6, the holder 85 comprises a support platform which, in this embodiment, comprises a plate 97 secured to the cover plate 95 and having a depression, or seat 99, formed in its upper surface for receiving the substrate 23 therein. Preferably, the seat 99 has a size and shape closely conforming to the size and shape of the substrate 23 to provide a close clearance fit of the substrate 23 in the seat. A groove 101 is formed within the upper surface of the support plate 97 and extends from the seat 99 out to the peripheral edge of the support plate to facilitate handling of the substrate 23, such as lifting the substrate out of the seat. A pair of retaining arms 103 is secured to the upper surface of the support plate 97 in spaced relationship with each other adjacent the peripheral edge of the seat 99. Each retaining arm 103 is pivotally secured at a pivot end 105 thereof to the upper surface of the support plate 97 by a suitable fastener 107. An opposite, free end 109 of each retaining arm 103 has an open slot 111 formed therein which is sized for receiving another fastener 113. A central portion 115 of each retaining arm 103 is configured for extending over the peripheral edge margin of the seat 99 (and hence the substrate 23 seated therein) and has a thickness such that the retaining arm engages the substrate to urge the substrate down into the seat during operation of the device 27.

To secure a substrate 23 on the device 27, the fasteners 113 at the free ends 109 of the arms 103 are loosened and the arms are pivoted out to an open position (e.g., as shown by one arm in FIG. 6) in which the arms do not extend over any portion of the seat 99 formed in the upper surface of the support plate 97. The substrate 23 is then placed in the seat 99 and the arms 103 are pivoted inward to a closed position (e.g., as shown by the other arm in FIG. 6) in which the shafts of the loosened fasteners 113 are received in the slots 111 formed in the free ends 109 of the arms 103. In their closed position, the central portions 115 of the retaining arms 103 extend over a peripheral edge margin of the seat in engagement with the substrate 23 seated therein. The fasteners 113 at the free ends 109 of the arms 103 are then tightened, causing the central portions 115 of the retaining arms 103 to generally urge the substrate 23 down into the seat 99 to inhibit movement of the substrate during operation of the device 27.

It is understood that linear reciprocation of the substrate 23 along a path normal to the substrate surface 29 may be performed with other conventional linear reciprocating devices having drive systems other than an electromagnetic drive system. It is also understood that movement devices capable of reciprocating the substrate along an axis other than normal to the substrate surface are known in the art and may be used without departing from the scope of this invention. For example, a movement device in which the substrate is reciprocated generally in the plane of the substrate surface (e.g., side-to-side) may be used. Devices in which a combination of reciprocating movements within and out of the plane of the substrate supported thereby, such as a device in which the substrate is rocked back and forth on an arcuate path, may be used. It is also contemplated that a movement device in which the substrate is rotated, such as the spin-coating device of FIG. 1, may be adapted to oscillate the substrate back and forth about the rotation axis of the device (e.g., first in one direction and then in another) and remain within the scope of this invention.

The movement device 27 may also move the substrate 23 in different ways, either sequentially or concurrently, such as by reciprocating the substrate up and down while the substrate is moved in an orbital path or rotated, or by varying the operating parameters of the movement device, such as to vary the speed (e.g. rotational speed or frequency) or displacement (e.g., amplitude or orbital path) of the substrate, during operation of the device.

The apparatus 21 of this third embodiment may also comprise a control system (not shown but similar to the control system 57 shown in FIG. 1) for controlling the drive system of the reciprocating movement device 27. For example, the control system may be used to monitor and control the drive system 83 start time, the amplitude and frequency of the device, the duration of operation of the drive system and other relevant parameters. It also contemplated that a heater (not shown but similar to the heater 353 shown in FIG. 21 and described later herein) or a cooling device (not shown) may be used to heat or cool the substrate 23 and/or liquid samples during operation of the reciprocating movement device 27.

In operation, a substrate 23 is seated in the holder 85 of the linear reciprocating device 27 in the manner described previously, with the mirror-finish surface 29 of the substrate exposed (e.g., facing up in the device shown in FIG. 6). The deposition device 25 is then operated to deposit one or more liquid samples on the exposed substrate surface 29. The liquid samples may be deposited serially, such as by the device 25 shown in FIG. 1, or simultaneously, such as by a deposition device (not shown) having multiple probes. It is contemplated that if only one liquid sample is deposited on the substrate surface 29, it may be located offset from the center of the substrate. In the event more than one liquid sample is deposited on the substrate surface 31, the liquid samples are preferably deposited thereon in spaced relationship with each other, with the samples all being generally offset from the center of the substrate or with one of the samples being deposited at the center of the substrate.

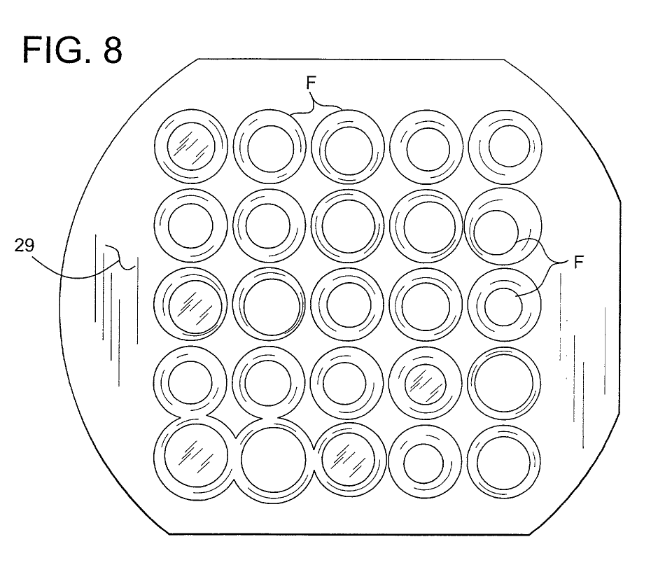

The reciprocating movement device 27 is then operated to effect a linear reciprocating movement of the substrate 23, such as up and down for the device shown in FIG. 6. Linear reciprocation of the substrate 23 subjects the liquid samples to a non-contact spreading force (e.g., due to acceleration), resulting in a shear stress at the liquid sample/substrate surface interface. When sufficiently large, this shear stress causes the liquid samples to spread or flatten on the substrate surface 29 to facilitate thinning of the liquid and evaporation thereof to thereby form corresponding thin films on the substrate surface. Linear reciprocation of the substrate 23 facilitates a more controlled spreading or flattening of the liquid sample on the substrate surface 29. For example, the vertical reciprocating movement of the substrate by the device 27 of the illustrated embodiment causes each liquid sample to spread or flatten on the substrate surface 29 in a generally circular pattern to form generally circular films F on the substrate 23, as shown in FIG. 8.

The liquid samples are preferably deposited on the substrate surface 29 with sufficient spacing therebetween such that the films formed on the substrate surface remain discrete from each other. However, it is understood that portions of adjacent films may overlap each other and remain within the scope of this invention, as along as a portion of each film remains sufficiently discrete from other films on the substrate surface 29 to permit the desired screening of each different film. For example, an area of at least about 0.1 mm² of each film formed on the substrate surface 29 is preferably discrete from other films formed thereon. It also contemplated that the liquid samples may alternatively be deposited on the substrate surface 29 during operation of the reciprocating movement device 27 so that the substrate surface 29 is already moving as liquid samples are deposited thereon.

### EXAMPLE 3

The apparatus 21 of the third embodiment was used to form a combinatorial array of silica-based films. Different compositions of a liquid solution comprising a silica source, a catalyst, a surfactant and a solvent were prepared and used as liquid sources for the deposition device (FIG. 1). A silicon wafer having a diameter of about 125 mm was placed in the holder 85 of the reciprocating movement device 27 of FIG. 6 in the manner described previously. The reciprocating movement device 27 was operated to reciprocate the wafer along a linear path normal to the wafer surface 29 at an amplitude of about 0.07 inches and at a frequency of about 60 Hz.

While the wafer was moving, the deposition device 25 was operated to serially dispense twenty-five samples of liquid on the wafer in a generally square pattern (e.g., a matrix of five rows of five samples each), with the center-to-center spacing between adjacent samples being about 17.5 mm. The volume of each liquid sample was in the range of about 2-5 microliters. Dispensing of the liquid samples on the wafer occurred over a period of about 12 minutes, and the wafer was reciprocated for a total duration of about 15 minutes (e.g., about 3 minutes longer than the time at which the last liquid sample is deposited on the substrate 23), after which movement of the substrate was stopped. Linear reciprocating movement of the wafer caused the liquid samples to spread over the wafer surface 29 to form films thereon. FIG. 8 illustrates a pattern of corresponding films F formed on the wafer surface. The diameter of each of the films formed on the wafer surface was approximately 17 mm. While not shown in the drawings, each of the films formed as a result of the vertical reciprocating movement has a generally concave cross section, with the center portion of the film being thinner than an annular area of the film toward the peripheral edge thereof.

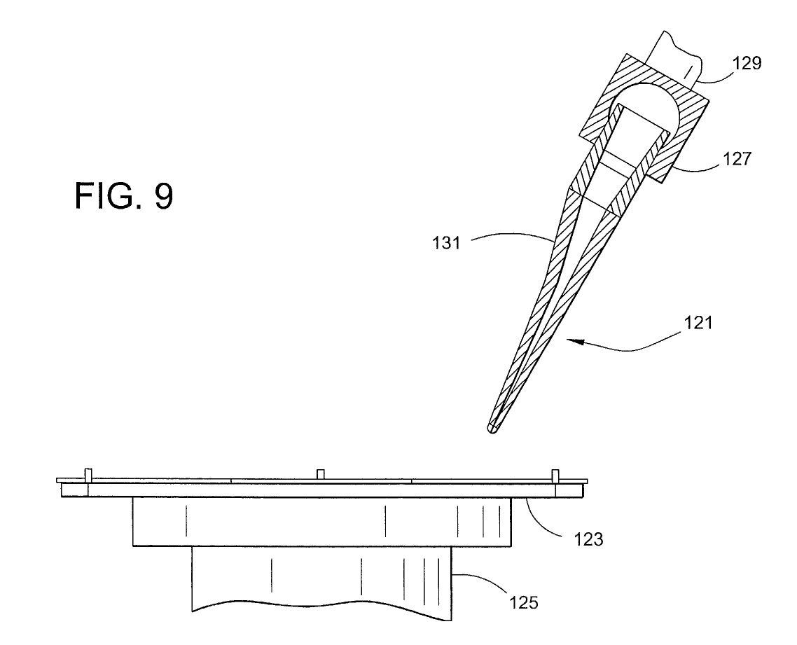

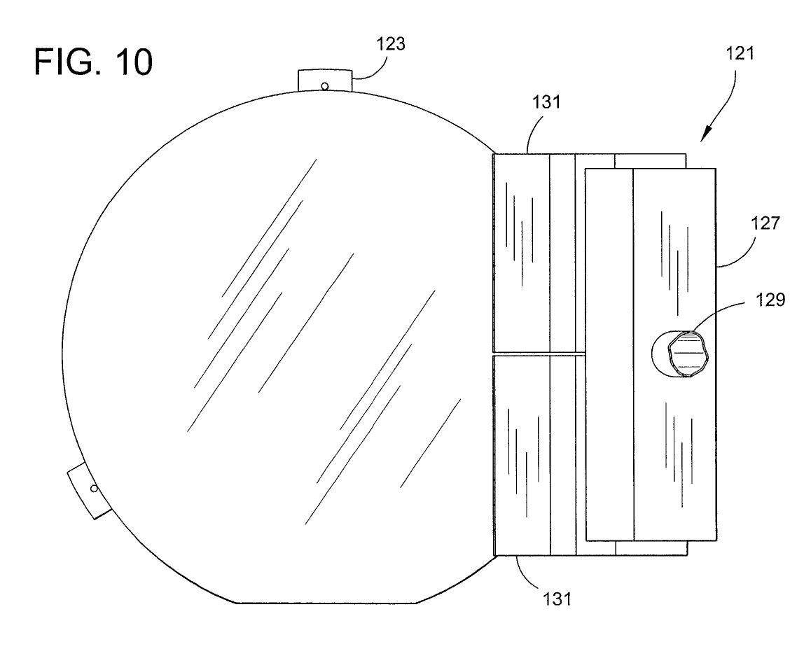

FIGS. 9 and 10 illustrate a portion of a fourth embodiment of apparatus 21 of the present invention in which a spreading force is applied to the liquid samples by pressurized gas, such as air, directed toward the substrate 23 by an air knife (broadly, a gas delivery device), generally indicated at 121. The substrate 23 is supported by a suitable holder 123 mounted on a stand 125, and the air knife 121 is positioned above the substrate at a distance of from about 1 mm up to about 100 mm. The air knife 121 comprises a manifold 127 in fluid communication with a source (not shown) of pressurized gas via a suitable gas line 129, and one or more nozzles 131 (two are shown in FIG. 10) secured to the manifold for receiving pressurized gas and directing the gas down toward the substrate surface.

Gas supplied to the nozzle(s) 131 is preferably at a pressure in the range of from about 1 psi to about 100 psi, and more preferably in the range of about 5 psi to about 20 psi. The nozzles 131 are preferably oriented to direct pressurized gas down toward the substrate surface 29 at an impact, or incident angle in the range of about 0° to about 90°, more preferably in the range of about 10° to about 80°, and most preferably in the range of about 30° to about 60°. General construction and operation of air knives is known in the art and will not be further described herein except to the extent necessary to describe the present invention. As an example, one preferred air knife 121 is available from Silvent of Sweden under the model designation 392 and comprises a pair of generally flat nozzles. Other conventional air knives 121 are shown and described in U.S. Pat. Nos. 2,135,406 and 5,505,995, the entire disclosures of which are incorporated herein by reference.

It is contemplated that the air knife 121 may be moveable relative to the substrate 23 during operation of the air knife to vary the direction at which air impacts the substrate surface (and hence the liquid samples deposited thereon). Also, the substrate 23 may be moveable instead of, or in addition to, the air knife 121, such as by being rotated or moved laterally relative to the air knife, without departing from the scope of this invention.

In operation, a substrate 23 is supported by the holder 123 with the mirror-finish surface 29 of the substrate exposed (e.g., facing up in the device 27 shown in FIG. 9). The deposition device 25 is then operated to deposit one or more liquid samples on the exposed substrate surface 29. The liquid samples may be deposited serially, such as by the device shown in FIG. 1, or simultaneously, such as by a deposition device having multiple probes. It is contemplated that if only one liquid sample is deposited on the substrate surface 29, it may be located offset from the center of the substrate. In the event more than one liquid sample is deposited on the substrate surface 29, the liquid samples are preferably deposited thereon in spaced relationship with each other, with the samples all being generally offset from the center of the substrate or with one of the samples being deposited at the center of the substrate.

The air knife 121 is then operated to direct pressurized gas toward the substrate surface 29 to impact the liquid samples. The pressurized gas impacting the liquid samples subjects the liquid samples to a spreading force, resulting in a shear stress at the liquid sample/substrate surface interface. When sufficiently large, this shear stress causes the liquid samples to spread or flatten on the substrate surface 29 to facilitate thinning of the liquid and the gas flow further facilitates evaporation of the liquid samples to thereby form corresponding thin films on the substrate surface.

The liquid samples are preferably deposited on the substrate surface 29 with sufficient spacing therebetween such that the films formed on the substrate surface remain discrete from each other. However, it is understood that portions of adjacent films may overlap each other and remain within the scope of this invention, as along as a portion of each film remains sufficiently discrete from other films on the substrate surface 29 to permit the desired screening of each different film. For example, an area of at least about 0.1 mm² of each film formed on the substrate surface 29 is preferably discrete from other films formed thereon.

It is contemplated that liquid samples on the substrate 23 may be subjected to non-contact spreading forces other than by the movement devices 27 described previously or by the air knife 121 without departing from the scope of this invention. For example, liquid samples may be dispensed onto the substrate 23 and the substrate may be tilted, or the substrate may be tilted prior to the delivery of liquid samples thereon, such that the liquid samples on the substrate are subjected to a gravitational force sufficient to spread the liquid samples on the substrate surface 29. The tilt of the substrate 23 may also be varied as the liquid samples spread over the substrate surface 29. It is also contemplated that the substrate may be moved, such as by the movement devices 27 described previously, or by the air knife 121, concurrently with tilting the substrate.

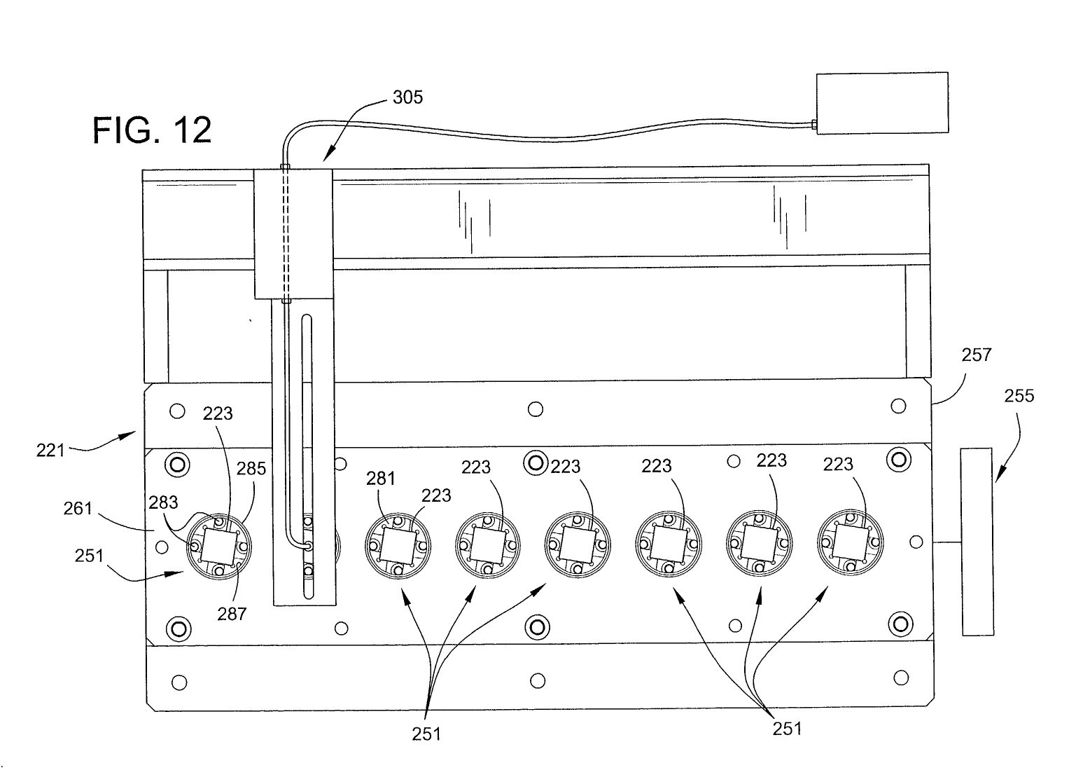

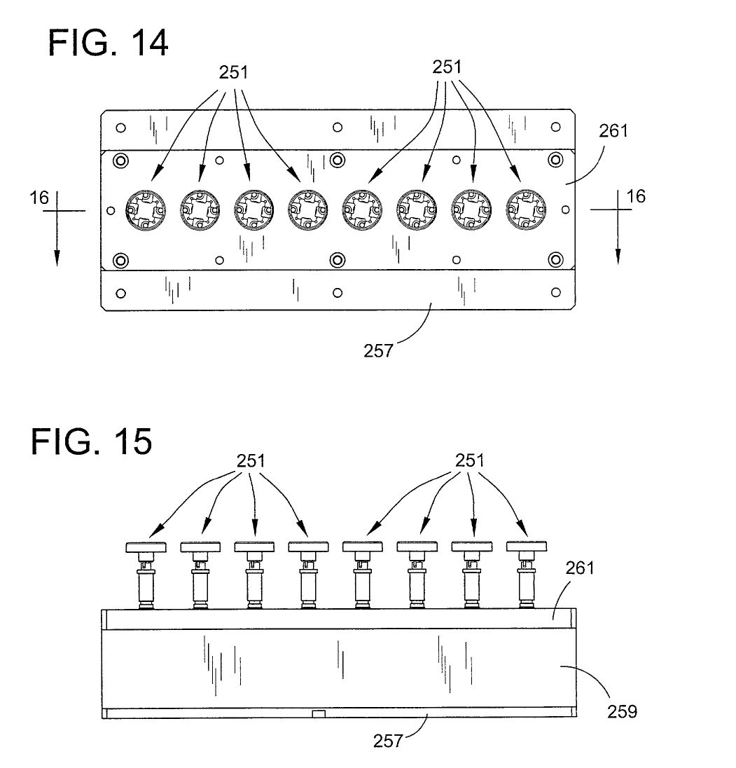

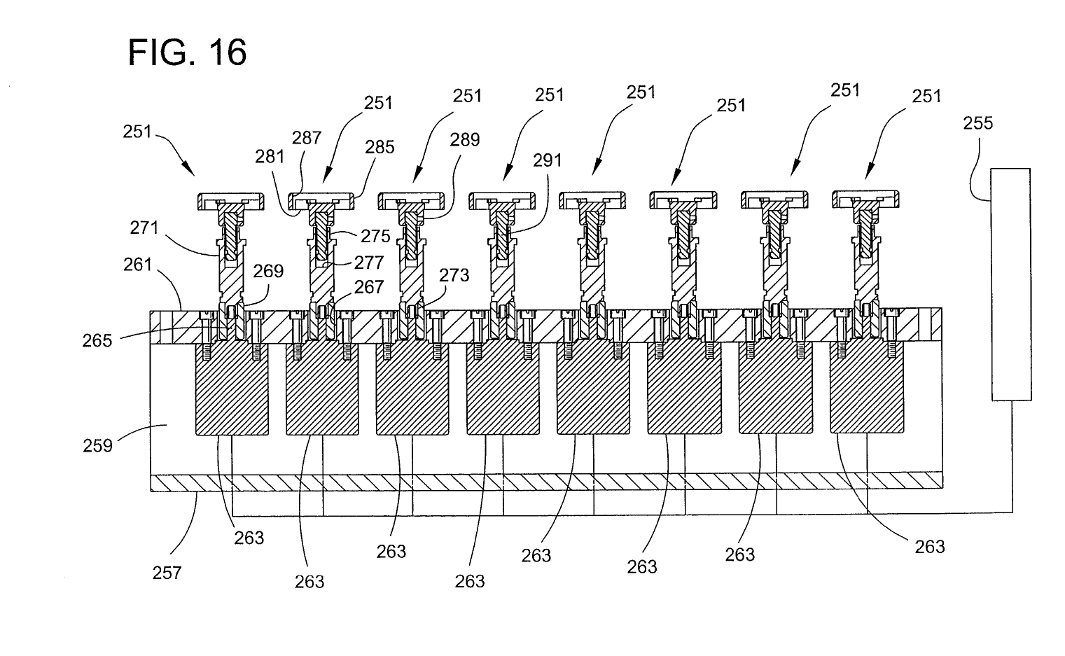

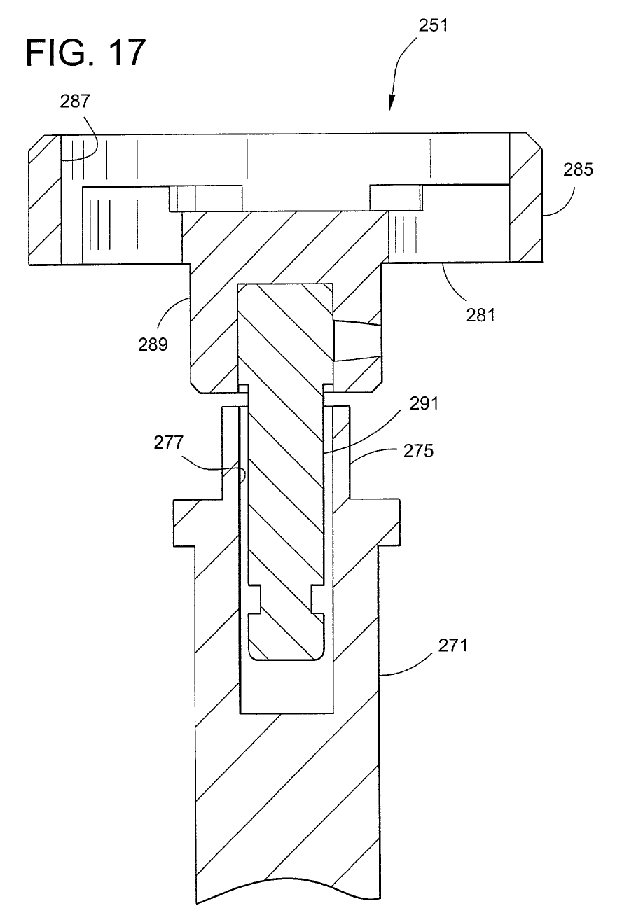

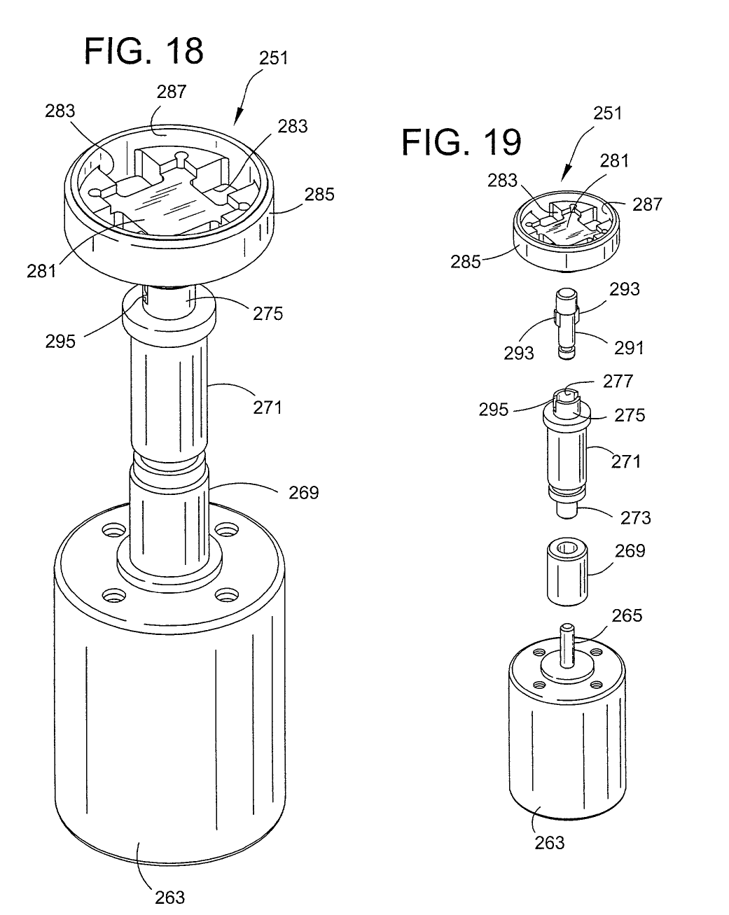

FIGS. 11-19 illustrate yet another embodiment of apparatus of the present invention for forming films on substrates. More particularly, apparatus of this embodiment, generally designated 221, effects the parallel formation of films on an array of substrates 223 each having the characteristics described above. However, each of the substrates 223 on which the films are formed by apparatus 221 of this embodiment are substantially smaller, such as preferably having a surface area of no greater than about one square inch, and more preferably a surface area of about 0.25 in.². In the embodiment shown, the substrates 223 are held by holders, each of which is generally indicated at 251. The apparatus 221 also includes a drive system, generally designated 253, operable for moving at least two of the substrates 223 (and preferably all of the substrates) of the array during overlapping durations of time to subject samples deposited on the substrates to non-contact spreading forces to thereby cause the samples to spread over the respective surfaces of the substrates to form films on the surfaces. The drive system 253 is preferably under the control of a programmable control system, generally designated 255, which controls the drive system to move the substrates 223 according to a predetermined program.

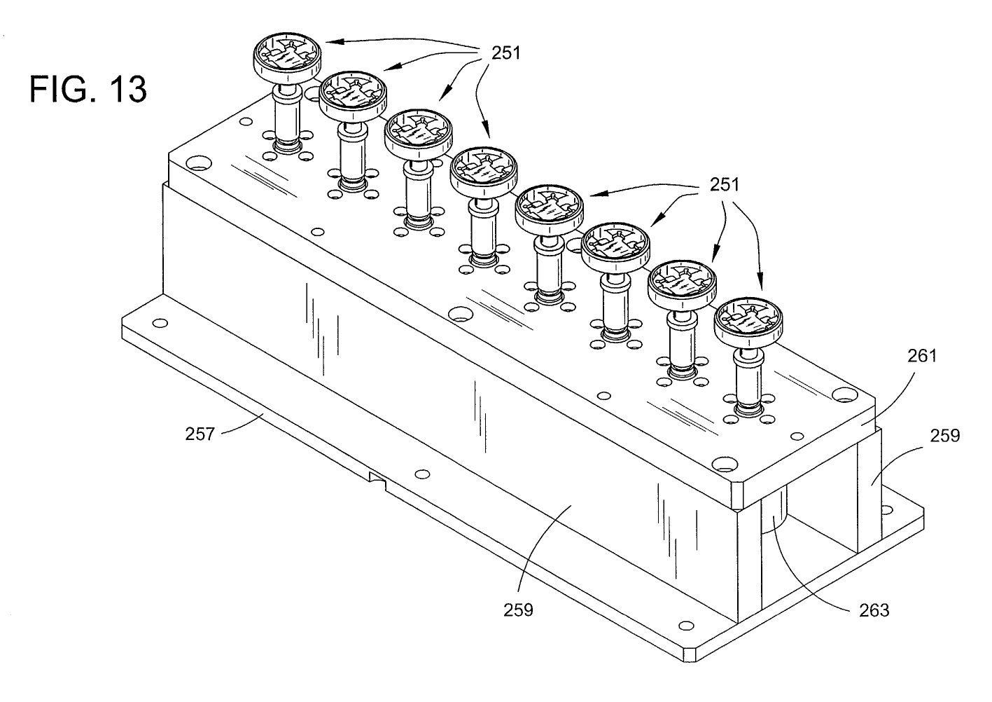

In the particular embodiment shown, the aforementioned drive system 253 is mounted on a frame having a base 257, side walls 259 extending up from the base, and a top wall 261 which spans the side walls (FIG. 13). The drive system 253 includes at least one and preferably a plurality of electric motors 263, one per substrate 223, mounted below the top wall 261 of the frame by suitable fasteners. An output shaft 265 of each motor 263 projects up into a hole 267 through the top wall 261 of the frame and is connected to a respective substrate holder 251 by a shaft assembly comprising a cylindric rotor and drive shaft designated 269 and 271, respectively. The rotor 269 is secured, as by a press fit, on the output shaft 265 of the motor 263 and has an outside dimension smaller than the hole 267 in the top wall 261 to provide the clearance necessary for the rotor to freely rotate as it is driven by the output shaft 265 of the motor. The drive shaft 271 has a lower end 273 of reduced diameter press fit (or otherwise secured) in the upper end of the rotor 269 and an upper end 275 of reduced diameter formed with a bore 277 which extends down into the body of the drive shaft.

The drive shaft 271, rotor 269 and output shaft 265 of the motor 263 preferably have a common vertical axis of rotation. The spacing between adjacent motors 263 and drive shaft assemblies will depend primarily on the size of the holders 251, which in turn will depend on the size of the substrates 223 to be held by the holders. In general, however, the centerline spacing between adjacent drive shafts 271 is preferably in the range of about 1 mm to about 500 mm, more preferably in the range of about 10 mm to about 100 mm, and even more preferably in the range of about 20 mm to about 80 mm. The construction of the drive shaft assembly may vary. For example, the rotor 269 and drive shaft 271 could be formed as a single piece, or as more than two pieces.

Given that the substrates 223 and holders 251 are relatively small in size, the motors 263 can also be relatively small. For example, each motor 263 may be a DC electric motor having a power output of about 3.5 W, a maximum speed of about 7000 rpm, a continuous torque of about 4.95 mNm and a stall torque of about 15.5 mNm. Other types of motors may also be used.

In the particular embodiment of FIGS. 11-19, each substrate holder 251 has a base 281 with openings 283 therein adjacent the periphery of the base, a circular rim 285 extending up from the base, and a recess 287 or depressed area in the upper surface of the base for receiving a substrate 223 therein. The recess 287 is sized and shaped to hold the substrate 223 in a substantially fixed position against lateral movement during rotation of the drive shaft 271. A central hub 289 projects down from the base 281 generally co-axially with respect to the respective drive shaft assembly. The hub 289 and drive shaft 271 are removably and drivingly connected by a connector 291 having an enlarged upper end received and secured (as by a press fit) in an opening in the hub and a lower end received and secured (as by a press fit) in the bore 277 in the drive shaft. The connector 291 is formed with one or more keys 293 receivable in keyway slots 295 extending down from the upper end 275 of the drive shaft 271 to prevent relative rotation of the drive shaft and the connector. The construction of the holder 251 and connector 291 may vary. For example, the holders 251 may have a construction similar to that of the holders 53, 65, 85, 123 of the various embodiments discussed above.

The substrates 223 are typically held in their respective seats by gravity and friction. Where necessary, other mechanisms can be used, such as vacuum, mechanical retainers, or other suitable means.

The number of substrate holders 251 and substrates 223 in the array may range from 2 to 96 or more. The configuration of the array may also vary. For example, the array shown in the drawings includes eight holders 251 and associated components, all arranged in the form of a 1×8 matrix. However, the holders 251 could be arranged in a matrix having any number of columns and rows, or they could be arranged in a geometric formation (e.g., a circle), or even randomly, without departing from the scope of this invention. For efficiency of space, it is preferred that the substrate holders 251 (and substrates 223 therein) be relatively closely spaced in an array which occupies an area (i.e., footprint) having a maximum dimension of less than about five feet by five feet, and more preferably occupies an area of about 1000 mm by about 300 mm, and even more preferably an area of about 100 mm by about 30 mm. If a robotic deposition system 225 is used to deposit samples on the substrates 223, the array should be confined to an area capable of being serviced by the robot system. By way of example, the footprint of the array shown in FIG. 13 is generally rectangular, having a length of about 300 mm and a width of about 125 mm.

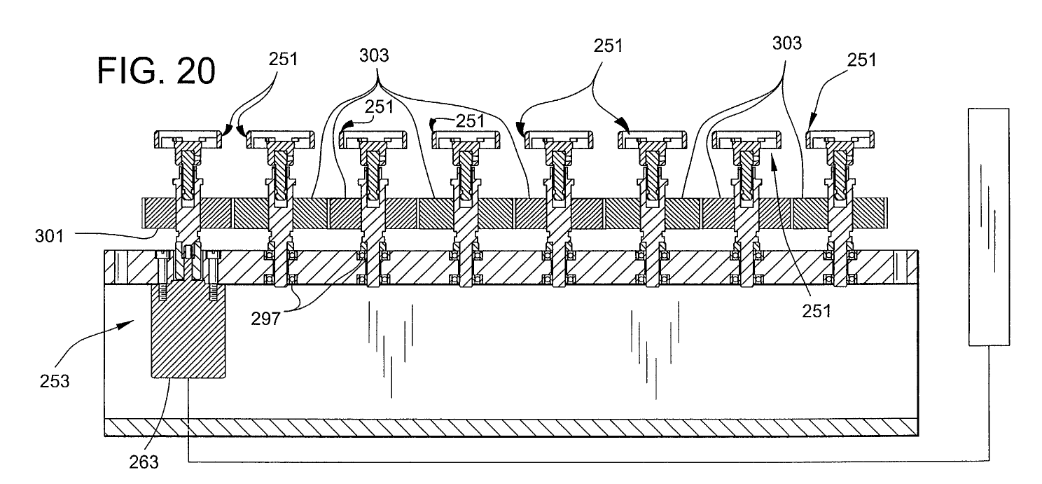

It is contemplated that the drive system 253 could have configurations other than those described above without departing from the scope of this invention. For example, the motors 263 could be mounted on multiple frames instead of a single common frame. Further, the motors 263 can be mounted so that their axes are other than vertical. A single motor 263 can also be used to move more than one substrate 223, as exemplified by the system 253 shown in FIG. 20. In this embodiment, a single motor 263 is drivingly connected to more than one (e.g., all) of the drive shaft assemblies, as by a gear 301 on the corresponding drive shaft 271 in mesh with a gear train comprising a plurality of gears 303 attached to the remaining drive shafts. In this embodiment, the drive shafts 271 are rotatably supported by suitable bearings 297 in the frame. The arrangement is such that rotation of the drive shaft 271 by the motor 263 causes the other drive shafts and associated holders 251 to rotate in unison.

Also, the drive system 253 can be operable to move the holders 251 in ways other than uni-directional movement. As described previously, other drive mechanisms can be employed to effect oscillatory movement, such as orbital movement, reciprocating movement (linear or otherwise) or rocking movement, or other forms of movement effective for subjecting liquid samples on the substrates 223 to non-contact spreading forces. By way of example, an array of holders 251 mounted on a common frame may be operably secured to the orbiting member of an orbital movement device similar to that shown in FIGS. 3 and 4, so that operation of the device effects orbital movement of the entire array of holders and substrates 223 held thereby. Alternatively, each holder 251 can be mounted on a separate orbital movement device. The drive system 253 can also be operable to move two or more of the substrates 223 in different ways, such as through different types of movement (e.g., rotational, orbital, linear) or at different rates and displacements.

The control system 255 for controlling the drive system 253 is preferably a computer based system capable of sending data to the drive system and receiving data from the drive system to monitor and control the operation of the system. Such data preferably includes, for each motor 263, a motor start time, amplitude and/or frequency of movement, duration of motor operation, and any other relevant parameters. The control system 255 is also programmable to permit a pre-determined parameter profile, such as a rate of acceleration, duration of operation, rotational speed and stop time to be pre-programmed. For example, the control system 255 may be programmed such that following deposition of one or more liquid samples on each substrate 223, the particular substrate is subjected to rotation for an initial time period, such as about 5-10 seconds, at a relatively low rotational speed, such as about 500 rpm, to promote spreading of the liquid samples on the substrate. The substrate 223 may then be accelerated to a higher rotational speed, such as about 2000 rpm for a longer duration, such as about 40 seconds, to promote further evaporation of the liquid. The system 255 can be used to control the operation of each motor 263 independent of the operation of the other motors (if more than one motor is used), so that different substrates 223 can be subjected to different movement conditions during the same run of experiments occurring during overlapping durations of time. It is believed that the hardware and software components of the control system 255 will be readily apparent to those of ordinary skill in this field and therefore will not be described in more detail.

Liquid samples may be deposited on the substrates 223 manually, or more preferably, by the robotic deposition system 225. It is also contemplated that a robotic system (not shown) may be provided for automatically (instead of manually) mounting the substrates 223 on and removing the substrates from the substrate holders 251 without departing from the scope of this invention.

### EXAMPLE 4

The above method was used to form a combinatorial array of silica-based films. Liquid solutions comprising a silica source, a catalyst, a surfactant and a solvent were prepared and used as liquid sources on the deposition device 25 of FIG. 1. Square silicon wafers each having a length and width of about 0.5 inches (e.g., a surface area of about 0.25 in.²) were individually placed in each of the eight substrate holders 251 of the apparatus 221 of FIG. 11. The deposition device 25 was operated to dispense a sample of liquid generally centrally on one of the wafers. The volume of the liquid sample was approximately 10 microliters. The control system 255 was used to operate the motor 263 corresponding to the wafer on which the liquid sample was dispensed according to a predetermined program pursuant to which the wafer was rotated at an acceleration rate of about 2000 rpm/sec until the rotational speed reached about 3000 rpm (e.g., about 1.5 seconds), and rotation then continued at a speed of 3000 rpm for about 5-10 seconds.

Rotation of the wafer subjected the liquid sample to a non-contact spreading force, resulting in the liquid sample spreading out over the wafer surface to form a film thereon. The control system 255 then caused rotation of the wafer to stop and the deposition device 25 was moved to the next wafer over a time period of about thirty seconds to dispense another liquid sample thereon. This process was repeated until a film was formed on each of the eight wafers.

FIG. 21 illustrates yet another embodiment of apparatus 321 of the present invention which is similar to the apparatus 221 of FIG. 11 but with a heating system, generally designated 351, positioned above the substrates for heating the substrates and the liquid samples deposited thereon. The heating system 351 of the illustrated embodiment comprises an infrared heater 353 positioned a distance of about 1 mm up to about 100 mm above the substrate. The heater 353 is preferably capable of generating heat at a temperature in the range of about 30° C. to about 500° C., more preferably in the range of about 50° C. to about 450° C., and most preferably in the range of about 100° C. to about 400° C. As an example, one preferred such heater 353 is a flat panel infrared heater available from Ogden of Arlington Heights, Ill. under the model designation FP2017 and is operable to generate heat at a temperature of up to about 200° C. If desired, a separate heater may be provided above each substrate holder 251 so that the temperature of one substrate 223 can be varied relative to the temperatures of the other substrates. The heating system can also be under the control of the control system 255 described above. It is also contemplated that a cooling device (not shown) may used instead of the heater 353 where cooling of the substrates 223, ambient environments or liquid samples is desired.

The apparatus 221, 321 described above can be used for forming thin films in the same manner previously described, the only differences being that liquid samples are deposited on more than one substrate 223, and more than one substrate is moved during overlapping durations of time. Liquid samples of the same or different composition and/or volume may be deposited on different substrates 223 and at the same or different locations on different substrates. Further, different numbers of samples may be placed on different substrates 223 (e.g., one sample on one substrate and more than one sample on other substrates), and the conditions under which the films are formed may be varied by varying the amplitude and/or frequency of movement(s), the duration of movement, etc. This is facilitated in certain embodiments by the use of the control system 255 described above. If a heater 353 or cooling device is used, the temperatures of the substrates 223 may also be controlled.

Following the formation of films on the substrates 23, 223 in accordance with any of the apparatus and methods described previously, the substrates are removed from their respective holders. It is contemplated that for some films, such as dielectric films, the substrates 23, 223 may be subjected to an annealing process in which the substrates are heated, such as to about 400° C., to promote decomposition of any organic material remaining in the film. However, annealing of the substrates 23, 223 may be omitted without departing from the scope of the invention.

The films formed on the substrates 23, 223 are then subjected to screening processes to determine, measure or otherwise characterize various properties of the films. As an example, U.S. Pat. No. 6,004,617 (Schulz et al.) discloses a number of such film properties which can be screened from a film formed on a substrate. As an additional example, mechanical properties such as the thickness, hardness and modulus of elasticity of each film may be measured. In one preferred technique for measuring the thickness of the film, commonly referred to as profilometry, the thickness of the film is determined using a stylus (not shown) in physical contact with the film. One machine (not shown) for determining the film thickness in such a manner is available from KLA/Tencor Corp. of San Jose, Calif., U.S.A. under the model designation P-15.

A preferred technique for determining the hardness and modulus of elasticity of each film is commonly referred to as nanoindentation, wherein a diamond tip (not shown) is driven down into the film and the resistance of the film to indentation by the diamond tip is measured. One preferred device (not shown) for carrying out such a screening is available from Hysitron Inc. of Minneapolis, Minn. and designated as a triboindentor nanomechanical test system. To use such a device, the films formed on the substrate 23, 223 are each preferably sized to have a width and length (or diameter) of at least about 50 nm to about 100 nm.

Electrical properties of each film, such as the capacitance and the dielectric constant (k) thereof, may also be determined. For example, a device (not shown) available from Solid State Measurements Inc. of Pittsburgh, Pa., U.S.A. under the model designation SSM 495 measures the capacitance of a film and, based on the thickness of the film (e.g., as determined by using the techniques described previously), determines the dielectric constant thereof. To use such a device, the films formed on the substrate 23, 223 are each preferably sized to have a surface area of at least about 3 mm². The films may also be screened for various optical properties such as the refractive index (n) and the extinction coefficient, which is a measurement of the amount of light absorbed by the film. One device (not shown) for determining these optical properties is available from n&k Technology of Santa Clara, Calif., U.S.A. under the model designation n&k Analyzer 1500.

Construction and operation of the screening devices described above are well known in the art and will not be further described herein. Moreover, it is contemplated that other conventional screening devices may be used to screen the films formed on the substrate 23, 223, including devices capable of screening for properties other than those described previously, without departing from the scope of this invention.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A method of forming a plurality of films on a surface of a substrate, the method comprising the steps of:
depositing at least two liquid samples on the substrate surface in generally spaced relationship with each other; and
moving the substrate so that the liquid samples are subjected to a spreading force sufficient to cause each sample to spread over the substrate surface to form a respective film thereon, at least a portion of each film being discrete from one or more other films formed on said substrate surface.

2. A method as set forth in claim 1 wherein the at least two liquid samples comprise at least two different liquid compositions.

3. A method as set forth in claim 1 wherein at least one of said liquid samples is deposited on the substrate surface generally at the center of said substrate surface.

4. A method as set forth in claim 1 wherein the substrate is subjected to uni-directional rotational movement about an axis extending generally perpendicular to the substrate surface.

5. A method as set forth in claim 1 wherein the substrate is subjected to orbital movement.

6. A method as set forth in claim 1 wherein the substrate is subjected to reciprocating movement.

7. A method as set forth in claim 6 wherein said reciprocating movement is a linear reciprocating movement.

8. A method as set forth in claim 1 wherein the substrate is subjected to a reciprocating movement about an axis extending generally perpendicular to the substrate surface.

9. A method as set forth in claim 1 wherein the substrate is subjected to different types of movement.

10. A method as set forth in claim 1 wherein each of said films has a thickness in the range of about 50 Å to about 1000 micrometers.

11. A method as set forth in claim 10 wherein each of said films has a thickness in the range of about 1,000 Å to about 10,000 Å.

12. A method as set forth in claim 1 wherein at least a portion of each of said films is substantially uniform to within a variation of about 0% to about 20%.

13. A method as set forth in claim 12 wherein at least a portion of each of said films is substantially uniform to within a variation of about 0% to about 10%.

14. A method as set forth in claim 13 wherein at least a portion of each of said films is substantially uniform to within a variation of about 0% to about 5%.

15. A method as set forth in claim 14 wherein at least a portion of each of said films is substantially uniform to within a variation of about 0% to about 3%.

16. A method as set forth in claim 1 wherein the volume of each liquid sample deposited on the substrate is in the range of about 0.1 microliters to about 10 milliliters.

17. A method as set forth in claim 16 wherein the volume of each liquid sample deposited on the substrate is in the range of about 0.5 microliters to about 500 microliters.

18. A method as set forth in claim 17 wherein the volume of each liquid sample deposited on the substrate is in the range of about 0.5 microliters to about 100 microliters.

19. A method as set forth in claim 18 wherein the volume of each liquid sample deposited on the substrate is in the range of about 0.5 microliters to about 50 microliters.

20. A method as set forth in claim 19 wherein the volume of each liquid sample deposited on the substrate is in the range of about 1 microliter to about 10 microliters.

21. A method as set forth in claim 1 wherein the substrate is generally circular and has a diameter in the range of about 3 inches to about 6 inches.

22. A method as set forth in claim 1 further comprising controlling the movement of the substrate by using a control system programmed to vary the movement of the substrate according to a predetermined program.

23. A method as set forth in claim 1 further comprising heating the substrate surface during movement of the substrate.

24. A method as set forth in claim 1 further comprising determining at least one characteristic of at least one film formed on the substrate surface.

25. A method of forming and evaluating a plurality of films on a surface of a substrate, the method comprising the steps of:
depositing at least two liquid samples on the substrate surface in generally spaced relationship with each other;
subjecting the liquid samples on the substrate surface to a non-contact spreading force sufficient to cause each sample to spread over the substrate surface to form a respective film thereon, at least a portion of each film being discrete from one or more other films formed on said substrate surface; and
determining at least one characteristic of at least one of the films formed on the substrate surface.

26. A method of forming a film on a surface of a substrate, the method comprising the steps of:
depositing a liquid sample on the substrate surface at a location generally offset from a center of the substrate surface, said liquid sample covering substantially less than the entire surface of the substrate; and
moving the substrate so that the liquid sample is subjected to a spreading force sufficient to cause the liquid sample to spread over the substrate surface to form a film thereon.

27. A method as set forth in claim 26 wherein the substrate is subjected to uni-directional rotational movement about an axis extending generally perpendicular to the substrate surface.

28. A method as set forth in claim 26 wherein the substrate is subjected to orbital movement.

29. A method as set forth in claim 26 wherein the substrate is subjected to reciprocating movement.

30. A method as set forth in claim 29 wherein said reciprocating movement is a linear reciprocating movement.

31. A method as set forth in claim 26 wherein the substrate is subjected to a reciprocating movement about an axis extending generally perpendicular to the substrate surface.

32. A method as set forth in claim 26 wherein the substrate is subjected to different types of movement.

33. A method as set forth in claim 26 wherein the film covers less than the entire surface of the substrate.

34. A method of forming and evaluating a film on a surface of a substrate, the method comprising the steps of:
depositing a liquid sample on the substrate surface at a location generally offset from a center of the substrate surface, said liquid sample covering substantially less than the entire surface of the substrate; and
subjecting the liquid sample on the substrate to a non-contact spreading force sufficient to cause the liquid sample to spread over the substrate surface to form a film thereon; and
determining at least one characteristic of said film formed on the substrate surface.

35. A method of forming a film on a surface of a substrate, the method comprising:
depositing a liquid sample on the substrate surface; and
oscillating the substrate to subject the liquid sample to a spreading force sufficient to cause the liquid sample to spread over the substrate surface to form a respective film thereon.

36. A method as set forth in claim 35 wherein said liquid sample is deposited on the substrate surface at a location off center with respect to the substrate surface.

37. A method as set forth in claim 35 wherein the step of oscillating the substrate comprises subjecting the substrate to orbital movement.

38. A method as set forth in claim 35 wherein the step of oscillating the substrate comprises subjecting the substrate to reciprocating movement.

39. A method as set forth in claim 38 wherein said reciprocating movement is a linear reciprocating movement.

40. A method as set forth in claim 35 wherein the step of oscillating the substrate comprises subjecting the substrate to an oscillatory movement about an axis extending generally perpendicular to the substrate surface.

41. A method as set forth in claim 35 wherein the substrate is subjected to different types of movement.

42. A method of forming a film on a surface of a substrate, the method comprising the steps of:
depositing a liquid sample on the substrate surface, said liquid sample covering substantially less than the entire surface of the substrate; and
directing a pressurized gas to impact said liquid sample to apply a spreading force thereto sufficient to cause the liquid sample to spread over the substrate surface to form a film thereon.

43. A method as set forth in claim 42 wherein said film covers less than the entire surface of the substrate.

44. A method as set forth in claim 42 wherein said depositing step comprises depositing at least two liquid samples on the substrate surface in generally spaced relationship with each other, said directing step comprising directing the pressurized gas to impact said liquid samples to apply a spreading force to each of the samples sufficient to cause the sample to spread over the substrate surface to form a respective film thereon, at least a portion of each film being discrete from other films formed on the substrate surface.

45. A method as set forth in claim 42 wherein the pressurized gas is directed toward the substrate surface at an angle of incidence in the range of about 0° to about 90°.

46. A method as set forth in claim 42 wherein the pressurized gas is directed toward the substrate surface at an angle of incidence in the range of about 10° to about 80°.

47. A method as set forth in claim 42 wherein the pressurized gas is directed toward the substrate surface at an angle of incidence in the range of about 30° to about 60°.

48. A method of forming an array of films for use in screening at least one characteristic of each of the films, said method comprising the steps of:
depositing at least two liquid samples onto at least one substrate such that the at least two liquid samples are at least partially discrete from each other; and
moving the at least on e substrate so that the liquid samples are subjected to a spreading force during overlapping durations of time, said spreading force being sufficient to cause each liquid sample to spread over the at least one substrate to form a respective film thereon, at least a portion of each film being discrete from one or more other films formed on said at least one substrate.

49. A method as set forth in claim 48 wherein the depositing step comprises depositing a liquid sample on each of at least two substrates in spaced relationship with each other, and wherein the moving step comprises moving the at least two substrates during overlapping durations of time, said movement being sufficient to cause each liquid sample to spread over the respective substrate on which it is deposited to form a film thereon.

50. A method as set forth in claim 49 wherein the liquid sample deposited on one of the substrates comprises a composition different from the liquid sample deposited on at least one other of said substrates.

51. A method as set forth in claim 48 wherein the depositing step comprises depositing at least two liquid samples on a single substrate in spaced relationship with each other, and wherein the moving step comprises moving the substrate to apply a spreading force to each of the liquid samples during overlapping durations of time, the spreading force being sufficient to cause each liquid sample to spread over the substrate to form a respective film thereon, at least a portion of each film being discrete from one or more other films formed on the substrate.

52. A method as set forth in claim 51 wherein at least one liquid sample deposited on the substrate has a composition different from at least one other liquid sample deposited on said substrate.

53. A method of forming and screening an array of films, said method comprising the steps of:
depositing at least two liquid samples onto at least one substrate such that the at least two liquid samples are at least partially discrete from each other; and
subjecting the liquid samples to a non-contact spreading force during overlapping durations of time, said spreading force being sufficient to cause each liquid sample to spread over the at least one substrate to form a respective film thereon, at least a portion of each film being discrete from one or more other films formed on said at least one substrate.

54. Apparatus for forming a plurality of films on a surface of a single substrate, said apparatus comprising:
a deposition device adapted for depositing a plurality of liquid samples on the surface of the substrate in generally spaced relationship with each other; and
a movement device capable of supporting the substrate with the liquid samples deposited thereon, said movement device being operable to move the substrate to thereby subject the liquid samples to a spreading force sufficient to cause the samples to spread over the substrate surface to form respective films thereon.

55. Apparatus as set forth in claim 54 wherein the movement device is operable to effect uni-directional rotational movement of the substrate about an axis extending generally perpendicular to the substrate surface.

56. Apparatus as set forth in claim 54 wherein the movement device is operable to effect orbital movement of the substrate along an orbital path.

57. Apparatus as set forth in claim 54 wherein the movement device is operable to effect reciprocating movement of the substrate.

58. Apparatus as set forth in claim 54 wherein said reciprocating movement is a linear reciprocating movement.

59. Apparatus as set forth in claim 54 wherein the movement device is operable to effect reciprocating movement of the substrate about an axis extending generally perpendicular to the substrate surface.

60. Apparatus as set forth in claim 54 wherein the movement device is operable to effect different types of movement of the substrate.

61. Apparatus as set forth in claim 54 further comprising a control system for controlling operation of the movement device, said control system being programmable to vary the movement of the substrate according to a predetermined program.

62. Apparatus for forming a film on a surface of a substrate, said apparatus comprising:
a deposition device for depositing a liquid sample on the surface of the substrate; and
a movement device capable of supporting the substrate with the liquid sample deposited thereon, said movement device being operable to subject the substrate to non-rotational movement whereby said non-rotational movement subjects the liquid sample to a spreading force sufficient to cause the liquid sample to spread over the substrate surface to form a film thereon.

63. Apparatus as set forth in claim 62 wherein the deposition device is operable to deposit a liquid sample on the substrate at a location offset from a center of the substrate surface.

64. Apparatus as set forth in claim 62 wherein the movement device is operable to subject the substrate to orbital movement.

65. Apparatus as set forth in claim 62 wherein the movement device is operable to subject the substrate to reciprocating movement.

66. Apparatus as set forth in claim 65 wherein said reciprocating movement is a linear reciprocating movement.

67. Apparatus as set forth in claim 62 wherein the movement device is operable to subject the substrate to different types of movement.

68. Apparatus for forming a film on a surface of a substrate, said apparatus comprising:
a deposition device adapted for depositing a liquid sample on the surface of the substrate;
a support for supporting the substrate with the liquid sample deposited thereon; and
a gas delivery device operable to direct a pressurized gas to impact said liquid sample to thereby cause the liquid sample to spread over the substrate surface to form a film thereon.

69. Apparatus as set forth in claim 68 wherein the gas delivery device is operable to direct pressurized gas toward the substrate surface at an angle of incidence in the range of about 0° to about 90° to impact the liquid sample.

70. Apparatus as set forth in claim 68 wherein the gas delivery device is operable to direct pressurized gas toward the substrate surface at an angle of incidence in the range of about 10° to about 80° to impact the liquid sample.

71. Apparatus as set forth in claim 68 wherein the gas delivery device is operable to direct pressurized gas toward the substrate surface at an angle of incidence in the range of about 30° to about 60° to impact the liquid sample.

72. A method of effecting the parallel formation of films, said method comprising
depositing liquid samples of different compositions on an array of substrates, each substrate having a surface for receiving a respective sample, and
moving at least two of the substrates of the array during overlapping durations of time to subject the samples on the at least two substrates to spreading forces sufficient to cause the samples to spread over respective surfaces of the substrates to form films on the surfaces.

73. A method as set forth in claim 72 further comprising controlling said movement of the substrates by using a single controller programmed to vary the movement of the substrates according to a predetermined program.

74. A method as set forth in claim 72 wherein said liquid samples are deposited on respective substrates robotically.

75. A method as set forth in claim 72 wherein said array of substrates occupies an area having a maximum dimension of no greater than about five feet.

76. A method as set forth in claim 72 wherein said depositing comprises placing a single sample on each substrate.

77. A method as set forth in claim 72 wherein at least one sample is deposited at a location off center with respect to a respective substrate.

78. A method as set forth in claim 72 wherein said depositing comprises placing multiple samples on at least one of said substrates.

79. A method as set forth in claim 78 wherein at least one of said multiple samples is deposited generally at the center of said at least one substrate.

80. A method as set forth in claim 72 wherein at least one substrate is subjected to uni-directional rotational movement about an axis extending generally perpendicular to said surface of the substrate.

81. A method as set forth in claim 72 wherein at least one substrate is subjected to orbital movement.

82. A method as set forth in claim 72 wherein at least one substrate is subjected to reciprocating movement.

83. A method as set forth in claim 82 wherein said reciprocating movement is a linear reciprocating movement.

84. A method as set forth in claim 72 wherein at least two of said substrates are subjected to different types of movement.

85. A method as set forth in claim 72 wherein at least two substrates are subjected to movements of different amplitude and/or frequency.

86. A method as set forth in claim 72 wherein said surface of each substrate has a surface area of less than about 1 in.².

87. A method as set forth in claim 86 wherein said surface of each substrate has a surface area of about 0.25 in.².

88. A method as set forth in claim 72 wherein said substrates are moved independently of one another by separate drive mechanisms.

89. A method as set forth in claim 72 wherein said substrates are moved in unison by a single drive mechanism.

90. A method as set forth in claim 72 wherein each of said samples has a volume in the range of about 0.1 microliters to about 10 milliliters.

91. A method as set forth in claim 90 each of said samples has a volume in the range of about 0.5 microliters to about 500 microliters.

92. A method as set forth in claim 91 wherein each of said samples has a volume in the range of about 0.5 microliters to about 100 microliters.

93. A method as set forth in claim 92 wherein each of said samples has a volume in the range of about 0.5 microliters to about 50 microliters.

94. A method as set forth in claim 93 wherein each of said samples has a volume in the range of about 1 microliter to about 10 microliters.

95. A method as set forth in claim 72 wherein each of said films has a thickness in the range of about 50 Å to about 100 micrometers.

96. A method as set forth in claim 95 wherein each of said films has a thickness in the range of about 1,000 Å to about 10,000 Å.

97. A method as set forth in claim 72 wherein each substrate is moved for a duration of time sufficient to cause a respective sample or samples thereon to spread out over the entire surface of the substrate.

98. A method as set forth in claim 72 further comprising heating said substrates.

99. A method as set forth in claim 92 further comprising heating said substrates to different temperatures.

100. A method as set forth in claim 72 further comprising measuring at least one characteristic of the film on at least one of the substrates.

101. A method of effecting the parallel formation of films, said method comprising
depositing liquid samples of different compositions on an array of substrates, each substrate having a surface for receiving a respective sample, and
subjecting liquid samples on at least two of the substrates of the array to non-contact spreading forces during overlapping durations of time whereby the spreading forces are sufficient to cause the samples to spread over respective surfaces of the substrates to form films on the surfaces.

102. A method of effecting the parallel formation of a plurality of films, said method comprising
depositing liquid samples on an array of substrates, each substrate having a surface for receiving a respective sample,
moving at least two of the substrates of the array during overlapping durations of time to subject the samples on the at least two substrates to spreading forces sufficient to cause the samples to spread over respective surfaces of the substrates to form films on the surfaces, and
controlling said movement of the substrates by using a single controller programmed to vary the movement of the substrates according to a predetermined program.

103. A method of effecting the parallel formation of a plurality of films, said method comprising
operating a robot system to deposit liquid samples on an array of substrates, each substrate having a surface for receiving a respective sample, and
moving at least two of the substrates of the array during overlapping durations of time to subject the samples on the at least two substrates to spreading forces sufficient to cause the samples to spread over respective surfaces of the substrates to form films on the surfaces.

104. A method as set forth in claim 103 further comprising controlling said movement of the substrates by using a single controller programmed to vary the movement of the substrates according to a predetermined program.

105. A method of effecting the parallel formation of a plurality of films, said method comprising
depositing liquid samples on an array of substrates occupying an area having a maximum dimension of no greater than about five feet, each substrate having a surface for receiving a respective sample, and
moving at least two of the substrates of the array during overlapping durations of time to subject the samples on the at least two substrates to spreading forces sufficient to cause the samples to spread over respective surfaces of the substrates to form films on the surfaces.

106. A method as set forth in claim 105 wherein said liquid samples are deposited on respective substrates robotically.

107. A method of effecting the parallel formation of a plurality of films, said method comprising
depositing liquid samples on an array of substrates, each substrate having a surface for receiving a respective sample, and
moving at least two of the substrates of the array in different ways during overlapping durations of time to subject the samples on the at least two substrates to spreading forces sufficient to cause the samples to spread over respective surfaces of the substrates to form films on the surfaces.

108. Apparatus for effecting the parallel formation of films, comprising
an array of holders for holding a plurality of substrates, each substrate having a surface for receiving a liquid sample thereon,
a robot system for depositing liquid samples on the surfaces of said substrates in said holders, and
a drive system operable for moving at least two of the holders of the array during overlapping durations of time to subject the samples on the at least two substrates to spreading forces to cause the samples to spread over respective surfaces of the substrates to form films on the surfaces.

109. Apparatus as set forth in claim 108 wherein said drive system comprises a single motor drivingly connected to at least two of said holders for moving the holders in unison.

110. Apparatus as set forth in claim 108 wherein each holder is removably connected to said drive system.

111. Apparatus as set forth in claim 110 wherein said drive system comprises a frame and at least one motor on the frame for rotating said holders about general parallel vertical axes.

112. Apparatus as set forth in claim 111 further comprising a plurality of motors mounted on the frame, each motor being operable to rotate a respective holder.

113. Apparatus as set forth in claim 111 wherein said drive system further comprises a plurality of generally vertical shafts on the frame rotatable by said at least one motor on generally parallel spaced apart axes, each of said holders being connected to a respective shaft for rotation with the shaft.

114. Apparatus as set forth in claim 108 further comprising a programmable control system for controlling said drive system to move said holders according to a predetermined program.

115. Apparatus as set forth in claim 108 further comprising a heater for heating at least one of said substrates.

116. Apparatus as set forth in claim 108 wherein said surface of each substrate has a surface area of no greater than about 1 in.².

117. Apparatus as set forth in claim 116 wherein said surface of each substrate has a surface area of about 0.25 in.².

118. Apparatus as set forth in claim 108 wherein said array of holders occupies an area having a maximum dimension of no greater than about five feet.

119. Apparatus for effecting the parallel formation of films, comprising:
an array of holders occupying an area having a maximum dimension of no greater than about five feet, each holder being adapted for holding a substrate having a surface for receiving a liquid sample thereon, and
a drive system operable for moving at least two of the holders of the array during overlapping durations of time to subject the samples to spreading forces sufficient to cause the samples to spread over respective surfaces of the substrates to form films on the surfaces.

120. Apparatus as set forth in claim 119 wherein said drive system comprises a single motor drivingly connected to at least two of said holders for moving the holders in unison.

121. Apparatus as set forth in claim 119 wherein each holder is removably connected to said drive system.

122. Apparatus as set forth in claim 121 wherein said drive system comprises a frame and at least one motor on the frame for rotating said holders about general parallel vertical axes.

123. Apparatus as set forth in claim 122 further comprising a plurality of motors mounted on the frame, each motor being operable to rotate a respective holder.

124. Apparatus as set forth in claim 122 wherein said drive system further comprises a plurality of generally vertical shafts on the frame rotatable by said at least one motor on generally parallel spaced apart axes, each of said holders being connected to a respective shaft for rotation with the shaft.

125. Apparatus as set forth in claim 119 further comprising a programmable control system for controlling said drive system to move said holders according to a predetermined program.

126. Apparatus as set forth in claim 119 further comprising a heater for heating at least one of said substrates.

127. Apparatus as set forth in claim 119 wherein said surface of each substrate has a surface area of no greater than about 1 in.².

128. Apparatus as set forth in claim 127 wherein said surface of each substrate has a surface area of about 0.25 in.².

129. Apparatus for effecting the parallel formation of films, comprising
an array of substrates, each substrate having a surface for receiving a liquid sample thereon,
a drive system operable for moving at least two of the substrates of the array during overlapping durations of time to subject the samples on the at least two substrates to spreading forces sufficient to cause the samples to spread over respective surfaces of the substrates to form films on the surfaces, and
a programmable control system for controlling said drive system to move said substrates according to a predetermined program.

130. Apparatus as set forth in claim 129 wherein said drive system comprises a single motor drivingly connected to at least two of said holders for moving the holders in unison.

131. Apparatus as set forth in claim 129 wherein each holder is removably connected to said drive system.

132. Apparatus as set forth in claim 131 wherein said drive system comprises a frame and at least one motor on the frame for rotating said holders about general parallel vertical axes.

133. Apparatus as set forth in claim 132 further comprising a plurality of motors mounted on the frame, each motor being operable to rotate a respective holder.

134. Apparatus as set forth in claim 132 wherein said drive system further comprises a plurality of generally vertical shafts on the frame rotatable by said at least one motor on generally parallel spaced apart axes, each of said holders being connected to a respective shaft for rotation with the shaft.

135. Apparatus as set forth in claim 129 further comprising a heater for heating at least one of said substrates.

136. Apparatus as set forth in claim 129 wherein said surface of each substrate has a surface area of no greater than about 1 in.².

137. Apparatus as set forth in claim 136 wherein said surface of each substrate has a surface area of about 0.25 in.².

138. Apparatus as set forth in claim 129 wherein said array of holders occupies an area having a maximum dimension of no greater than about five feet.
